(19) United States
(12) Patent Application Publication
(10) Pub. No.: US 2024/0141134 A1
(43) Pub. Date: May 2, 2024

(54) COMPOSITIONS, ARTICLES, AND METHODS RELATED TO HYDROGEN GAS SENSORS

(71) Applicant: Massachusetts Institute of Technology, Cambridge, MA (US)

(72) Inventors: Timothy Manning Swager, Newton, MA (US); Lennon Shaoxiong Luo, Cambridge, MA (US)

(73) Assignee: Massachusetts Institute of Technology, Cambridge, MA (US)

(21) Appl. No.: 18/489,731

(22) Filed: Oct. 18, 2023

Related U.S. Application Data
(60) Provisional application No. 63/380,051, filed on Oct. 18, 2022.

(51) Int. Cl. C08K 3/08; C09D 171/00

(52) U.S. Cl. CPC C08K 3/08; C09D 171/00; C08K 2201/011

(57) ABSTRACT

Compositions, articles, and methods related to hydrogen gas sensors are generally described.

### RELATED APPLICATIONS

This application claims priority under 35 U.S.C. § 119(e) to U.S. Provisional Application No. 63/380,051, filed Oct. 18, 2022, and entitled “Hydrogen Gas Sensor”, which is incorporated herein by reference in its entirety for all purposes.

### TECHNICAL FIELD

Compositions, articles, and methods related to hydrogen gas sensors are generally described.

### BACKGROUND

Hydrogen gas (H₂) is abundant, widely used in many industrial processes, and represents an attractive element in renewable energy schemes. However, H₂ is highly flammable and can explode when its concentration in air exceeds 4%, therefore presenting significant safety risks. Moreover, its buoyant, colorless, and odorless nature makes H₂ a challenging gas to detect. Therefore, it is imperative to develop sensitive and selective H₂ sensors that operate under ambient conditions for leak detection during H₂ production, transportation, storage, and/or usage.

### SUMMARY

The present disclosure is generally related to compositions, articles, and methods for hydrogen gas sensing. The subject matter of the present invention involves, in some cases, interrelated products, alternative solutions to a particular problem, and/or a plurality of different uses of one or more systems and/or articles.

According to some embodiments, a composition configured for determining hydrogen gas at low concentration is described. In certain embodiments, the composition comprises a porous polymer having a glass transition temperature greater than or equal to 200° C. and metal nanoparticles contained within the porous polymer, wherein an electronic state of at least a portion of the metal nanoparticles changes upon exposure to hydrogen gas.

According to certain embodiments, an article is described. In some embodiments, the article comprises a substrate and a composition disposed on at least a portion of the substrate. In certain embodiments, the composition comprises a porous polymer having a glass transition temperature greater than or equal to 200° C. and metal nanoparticles contained within the porous polymer, wherein an electronic state of at least a portion of the metal nanoparticles changes upon exposure to hydrogen gas.

In certain embodiments, a method of sensing hydrogen gas is described. The method comprises, in some embodiments exposing a composition to the hydrogen gas, wherein the composition comprises a porous polymer and metal nanoparticles contained within the porous polymer, and determining a response of the composition.

One aspect of the disclosure herein is a detector for hydrogen comprising a colloid, wherein the colloid comprises:
a. iptycene-containing poly(arylene ether)s-supported palladium nanoparticles;
b. single-walled carbon nanotubes (SWCNTs)-based chemiresistors; and/or
c. graphene field-effect transistors (GFETs).

In one embodiment of the detector disclosed herein, the SWCNTs are presorted with pentiptycene-containing poly(p-phenylene ethynylene)s (PPEs) and thermally annealed.

In one embodiment of the detector disclosed herein, the iptycene-containing poly(arylene ether)s-supported palladium nanoparticles comprise a compound selected from the group consisting of:

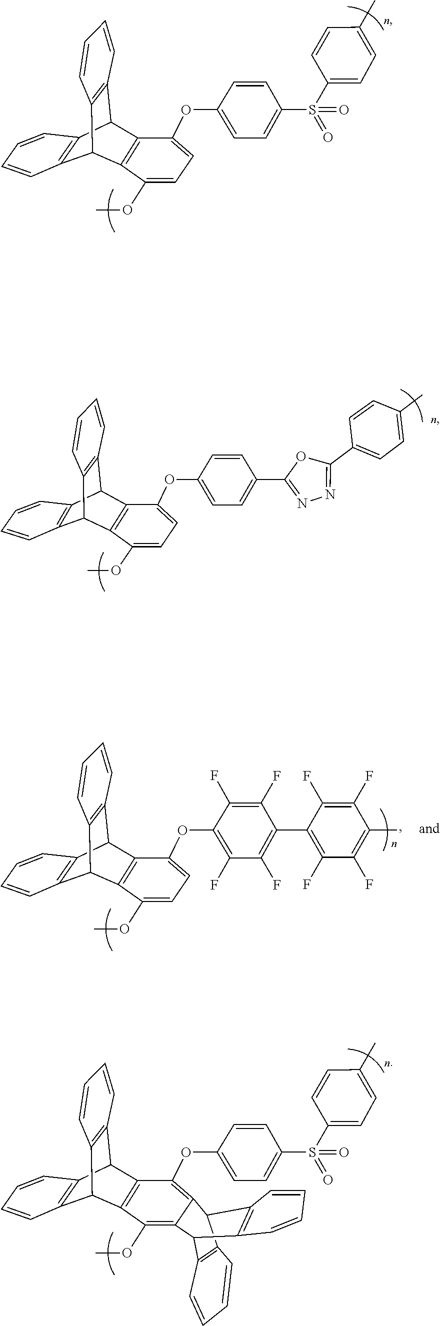

Other advantages and novel features of the present invention will become apparent from the following detailed description of various non-limiting embodiments of the invention when considered in conjunction with the accompanying figures. In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF THE DRAWINGS

Non-limiting embodiments of the present invention will be described by way of example with reference to the accompanying figures, which are schematic and are not intended to be drawn to scale. In the figures, each identical or nearly identical component illustrated is typically represented by a single numeral. For purposes of clarity, not every component is labeled in every figure, nor is every component of each embodiment of the invention shown where illustration is not necessary to allow those of ordinary skill in the art to understand the invention. In the figures:

FIG. 1 is, in accordance with certain embodiments, a cross-sectional schematic diagram of an article comprising a substrate and a composition disposed on the substrate.

FIG. 2A is, in accordance with certain embodiments, a top-view schematic diagram of an article comprising a substrate and a composition patterned on the substrate.

FIG. 2B is, in accordance with certain embodiments, a top-view schematic diagram of an article comprising a substrate and a composition patterned on the substrate in the form of lines and/or gratings.

FIG. 3A is, in accordance with certain embodiments, a cross-sectional schematic diagram representing a method of exposing a composition to hydrogen gas.

FIG. 3B is, in accordance with certain embodiments, a cross-sectional schematic diagram representing a method of exposing a composition disposed on a substrate to hydrogen gas.

FIG. 4 shows, in accordance with certain embodiments, chemical structures of iptycene-containing poly(arylene ether)s (PAEs).

FIG. 5 is, in accordance with certain embodiments, a schematic diagram of a representative synthesis of palladium nanoparticles (Pd NPs) supported by iptycene-containing PAEs.

FIG. 6A is, in accordance with certain embodiments, a transmission electron microscopy (TEM) image of Trip-SO₂-Pd.

FIG. 6B is, in accordance with certain embodiments, a TEM image of Trip-Oxa-Pd.

FIG. 6C is, in accordance with certain embodiments, a TEM image of Trip-F-Pd.

FIG. 6D is, in accordance with certain embodiments, a TEM image of Pent-SO₂-Pd.

FIG. 7 shows, in accordance with certain embodiments, chemiresistive responses of PAE-supported Pd NPs to 1% H₂ in dry air for 10 minutes (N≥4).

FIG. 8 is, in accordance with certain embodiments, a schematic diagram of a proposed H₂ sensing mechanism of PAE-supported Pd NPs.

FIG. 9 shows, in accordance with certain embodiments, chemiresistive responses of Pent-SO₂-Pd to 1% H₂ in nitrogen (N≥4).

FIG. 10 shows, in accordance with certain embodiments, X-ray Photoelectron Spectroscopy (XPS) spectra of the Pd 3d region of Pent-SO₂-Pd before (top) and after (bottom) 1% H₂ exposure in nitrogen.

FIG. 11 shows, in accordance with certain embodiments, transfer characteristics change of GFETs functionalized with Pent-SO₂-Pd in response to 1% H₂ in dry air for 10 minutes (N≥16).
FIG. 12A shows, in accordance with certain embodiments, chemical structures of P1 and P2.
FIG. 12B shows, in accordance with certain embodiments, structural properties of pentiptycene.
FIG. 12C is, in accordance with certain embodiments, a schematic drawing of the dispersion of SWCNTs between pentiptycene polymers.
FIG. 12D shows, in accordance with certain embodiments, ultraviolet-visible-near infrared (UV-Vis-NIR) absorption spectra of pristine SWCNTs and sorted SWCNTs dispersions in ortho-dichlorobenzene (oDCB), wherein the inset shows photographs of dispersions of (i) p-SWCNT, (ii) P1-SWCNT, and (iii) P2-SWCNT in oDCB.
FIG. 13 shows, in accordance with certain embodiments, chemiresistive responses of Pent-SO₂-Pd on various SWCNTs to 1% H₂ in dry air for 10 minutes (N≥4).
FIG. 14 shows, in accordance with certain embodiments, a summary of chemiresistive responses of Pent-SO₂-Pd on various SWCNTs to 1% H₂ for 10 minutes in different relative humidity levels (N≥4).
FIG. 15 shows, in accordance with certain embodiments, a comparison of chemiresistive responses of Pent-SO₂-Pd on various SWCNTs to 1% H₂ in dry air for 10 minutes before and after the thermal annealing process (N≥4).
FIG. 16A shows, in accordance with certain embodiments, chemiresistive responses of thermally annealed P2-SWCNT/Pent-SO₂-Pd to different concentrations (0.1-1.0%) of H₂ in dry air.
FIG. 16B shows, in accordance with certain embodiments, chemiresistive responses of thermally annealed P2-SWCNT/Pent-SO₂-Pd to different concentrations (100-500 ppm) of H₂ in dry air.
FIG. 16C shows, in accordance with certain embodiments, a summary of chemiresistive responses of thermally annealed P2-SWCNT/Pent-SO₂-Pd to different concentrations of H₂ in dry air.
FIG. 16D shows, in accordance with certain embodiments, a calibration curve of thermally annealed P2-SWCNT/Pent-SO₂-Pd to 100-500 ppm of H₂ in dry air for 10 minutes (N≥4).

FIG. 17 shows, in accordance with certain embodiments, a summary of chemiresistive responses of thermally annealed P2-SWCNT/Pent-SO₂-Pd in response to different volatile organic vapors and gases, wherein devices were exposed to the analytes at 500 ppm in dry air for 10 minutes (N≥4).

FIG. 18A shows, in accordance with certain embodiments, TEM images of Pd NPs synthesized in the absence of polymer.

FIG. 18B shows, in accordance with certain embodiments, TEM images of Pd NPs synthesized in the presence of Trip-SO₂, showing a significant size difference relative to the Pd NPs shown in FIG. 18A.

FIG. 19A is, in accordance with certain embodiments, an electron image of Trip-SO₂-Pd.

FIGS. 19B-19C show, in accordance with certain embodiments, energy dispersive X-ray (EDX) elemental mapping of Trip-SO₂-Pd.

FIG. 20A is, in accordance with certain embodiments, the chemical structure of poly(ether ether sulfone) (PEES).

FIG. 20B is, in accordance with certain embodiments, a photograph of Pd NPs synthesized in the presence of PEES, showing rapid aggregation and phase separation of Pd NPs.

FIG. 21 is, in accordance with certain embodiments, a schematic diagram of the fabrication of a SWCNT-based chemiresistive device with PAE-supported Pd NPs.

FIG. 22A is, in accordance with certain embodiments, a scanning electron microscopy (SEM) image of Trip-SO₂-Pd.

FIG. 22B is, in accordance with certain embodiments, a SEM image of Trip-Oxa-Pd.

FIG. 22C is, in accordance with certain embodiments, a SEM image of Trip-F-Pd.

FIG. 22D is, in accordance with certain embodiments, a SEM image of Pent-SO₂-Pd.

FIG. 23 is, in accordance with certain embodiments, a design scheme of a graphene field effect transistor (GFET).

FIG. 24 is, in accordance with certain embodiments, a Raman spectrum of single layer graphene used in GFETs, wherein excitation=633 nm.

FIG. 25 shows, in accordance with certain embodiments, an averaged chemiresistive response of GFETs with PAE-supported Pd NPs and bare graphene to 1% H₂ in dry air for 10 minutes (N≥16).

FIG. 26 shows, in accordance with certain embodiments, a comparison of sensor responses of Pd-based H₂ sensors in response to 1% H₂ at room temperature in air.

FIG. 27 shows, in accordance with certain embodiments, chemiresistive responses of Pent-SO₂-Pd to 1% H₂ in dry air for 10 minutes after different thermal annealing times.

FIG. 28 shows, in accordance with certain embodiments, XPS spectra of the Pd 3d region of Pent-SO₂-Pd before (top) and after (bottom) thermal annealing.

FIG. 29 is, in accordance with certain embodiments, a TEM image of Pent-SO₂-Pd after thermal annealing, showing a slight increase in NP diameters (5-10 nm).

FIG. 30 shows, in accordance with certain embodiments, Raman spectra of SWCNTs before and after thermal annealing, wherein excitation=633 nm.

FIG. 31 shows, in accordance with certain embodiments, a humidity effect of thermally annealed P2-SWCNT/Pent-SO₂-Pd to 1% H₂ in air for 10 minutes.

FIG. 32 is, in accordance with certain embodiments, a proton nuclear magnetic resonance (¹H NMR) spectrum of Trip-SO₂(500 MHz, DMF-d₇).

FIG. 33 is, in accordance with certain embodiments, a ¹H NMR spectrum of Trip-Oxa (500 MHz, DMF-d₇).

FIG. 34 is, in accordance with certain embodiments, a ¹H NMR spectrum of Trip-F (500 MHz, DMF-d₇).

FIG. 35 is, in accordance with certain embodiments, a ¹H NMR spectrum of Pent-SO₂ (500 MHz, DMF-d₇).

### DETAILED DESCRIPTION

Compositions, articles, and methods related to hydrogen gas sensors are generally described. In certain embodiments, a composition configured to determine hydrogen gas at low concentration is described. The composition may, in some embodiments, comprise a porous polymer and metal nanoparticles contained within the porous polymer. In certain embodiments, for example, the metal nanoparticles are contained within one or more pores of the porous polymer. In accordance with certain embodiments, the porous polymer and the metal nanoparticles are configured such that the metal nanoparticles have an average characteristic dimension (e.g., an average diameter) that is smaller than or equal to an average characteristic dimension (e.g., an average diameter) of the one or more pores of the porous polymer. The porous polymer may be substantially rigid, in some embodiments, such that the porous polymer has a relatively high glass transition temperature (e.g., a glass transition temperature of greater than or equal to 200° C.). Such a configuration of nanoparticles incorporated into a framework of the substantially rigid, porous polymer may, in certain embodiments, prevent the metal nanoparticles from agglomerating and/or undergoing Ostwald ripening. Advantageously, the small (e.g., less than or equal to 10 nm in average diameter) metal nanoparticles may therefore have an increased surface area available for exposure to, and detection of, hydrogen gas.

The metal nanoparticles may have any of a variety of suitable configurations and/or mechanisms of detecting hydrogen gas. In some embodiments, for example, at least a portion of the metal nanoparticles are in a neutral valence state, and the metal nanoparticles in the neutral valence state may be configured to be oxidized upon exposure to hydrogen gas. In certain embodiments, at least a portion of the metal nanoparticles are in an oxidized valence state, and the metal nanoparticles in the oxidized valence state may be configured to be reduced by hydrogen upon exposure to hydrogen gas. Any of a variety of suitable metals may be employed. In certain non-limiting embodiments, for example, the metal nanoparticles comprise palladium. Employing a mixture of metals (and/or a mixture of heteroatoms) may, in certain embodiments, advantageously increase a rate of reaction with hydrogen gas and/or prevent irreversible reactions with one or more interfering species.

The composition may be disposed on a substrate, in certain embodiments. For example, in accordance with some embodiments, the composition is coated on an electrical and/or optical device (e.g., a sensor) that is responsive to change in an electronic state of the metal nanoparticles. In certain embodiments, configuring the composition and the substrate in this way advantageously provides a device that can electrically and/or optically detect a presence of hydrogen gas and/or an amount of the hydrogen gas. The substrate comprises an electrically conductive material, in some embodiments. For example, depending on the composition of the porous polymer and/or the metal nanoparticles, the substrate may comprise carbon (e.g., carbon nanotubes, graphene, etc.), a conducting polymer, and/or a metal oxide. In some embodiments, the substrate comprises a transistor (e.g., a graphene field-effect transistor). The substrate may, in some embodiments, comprise an optical device, such as a waveguide, a microphotonic device, and/or a fiber optic.

In accordance with certain embodiments, the composition is exposed to hydrogen gas. In some embodiments, for example, the porous polymer is at least partially permeable to hydrogen gas such that the hydrogen gas contacts the metal nanoparticles contained within the porous polymer upon exposure to hydrogen gas. The metal nanoparticles may be configured such that an electronic state of at least a portion of the metal nanoparticles changes upon exposure to hydrogen gas. In some embodiments, for example, at least a portion of the metal nanoparticles in a neutral valence state (e.g., palladium metal) react by absorption of hydrogen upon exposure to hydrogen gas, thereby forming a metal hydride (e.g., palladium-hydride). In certain embodiments, at least a portion of the metal nanoparticles in an oxidized valence state (e.g., palladium oxide) are reduced to a neutral valence state (e.g., palladium metal) upon exposure to hydrogen gas. In certain embodiments, as the electronic state (e.g., electronic valence state) of the metal nanoparticles changes, an electrical and/or optical property of the metal nanoparticles changes. In accordance with some embodiments, the change in the electrical and/or optical property is detected by the substrate that the composition is disposed on as an electrical and/or optical response of the composition. In certain embodiments, for example, the response of the composition is an electrical response (e.g., a change in resistance and/or conductivity of the composition) that is detected by an electrical sensor and/or detector. In some embodiments, the response of the composition is an optical response (e.g., a change in plasmonic resonance of the composition, a change in refractive index of the composition) that is detected by an optical sensor and/or detector.

According to some embodiments, the hydrogen gas is detected in the presence of one or more additional gases. In certain embodiments, an amount of the hydrogen gas is determined. For example, in some embodiments, a magnitude of the change in the electrical and/or optical property of the metal nanoparticles is detected by the substrate that the composition is disposed on.

The compositions, articles, and methods related to hydrogen gas sensing may be utilized in any of a variety of industrial processes, including, for example, steam-methane reforming, electrolysis (e.g., water splitting) processes, thermochemical processes, photolytic processes, and/or biological processes. In certain embodiments, for example, the compositions and articles are used as hydrogen sensors (e.g., microsensors) to detect a presence and/or an amount of hydrogen gas.

According to certain embodiments, the composition comprises a porous polymer. As used herein, the term “porous” is given its ordinary meaning in the art and refers to a solid material containing void space(s) (e.g., pores) not occupied by the main framework of atoms that make up the structure of the solid material. The porous polymer may comprise a plurality of pores (e.g., open pores), in some embodiments. In certain embodiments, as described elsewhere herein in greater detail, the pores of the porous polymer are accessible and/or permeable to fluids (e.g., gases and/or liquids), including, for example, hydrogen gas. In certain embodiments, a composition comprising a porous polymer that is permeable to hydrogen gas may advantageously be used to detect a presence and/or an amount of hydrogen gas at low concentration.

In some embodiments, the void space(s) in the porous polymer are intrinsic and defined by the molecular structure of the porous polymer that prevents a dense packing of polymer chains. In certain embodiments, the void space(s) in the porous polymer are introduced by processing the porous polymer. For example, in certain embodiments, the porous polymer is processed thermally, chemically, and/or photochemically to introduce one or more void spaces. In some embodiments, for example, the porous polymer comprises a first portion of void spaces that are intrinsic as defined by the molecular structure of the porous polymer and a second portion of void spaces that are introduced by processing the porous polymer. According to certain embodiments, the porosity or free volume of the porous polymer is advantageously tunable, in some embodiments, depending on the choice of monomer and/or comonomer employed to produce the porous polymer.

The plurality of pores may have any of a variety of suitable average characteristic dimensions (e.g., average diameters). In some embodiments, for example, the plurality of pores have an average characteristic dimension greater than or equal to 2 nm, greater than or equal to 3 nm, greater than or equal to 4 nm, greater than or equal to 5 nm, greater than or equal to 6 nm, greater than or equal to 7 nm, greater than or equal to 8 nm, or greater than or equal to 9 nm. In certain embodiments, the plurality of pores have an average characteristic dimension less than or equal to 10 nm, less than or equal to 9 nm, less than or equal to 8 nm, less than or equal to 7 nm, less than or equal to 6 nm, less than or equal to 5 nm, less than or equal to 4 nm, or less than or equal to 3 nm. Combinations of the above recited ranges are possible (e.g., the plurality of pores have an average characteristic dimension greater than or equal to 2 nm and less than or equal to 10 nm, the plurality of pores have an average characteristic dimension greater than or equal to 4 nm and less than or equal to 6 nm). Other ranges are also possible. The average characteristic dimension of the plurality of pores may be determined by gas absorption isotherm measurements and/or X-ray scattering.

According to certain embodiments, the porous polymer is at least partially microporous. In some embodiments, for example, the porous polymer comprises one or more pores having an average characteristic dimension (e.g., an average diameter) less than 2 nm.

In some embodiments, the porous polymer is at least partially mesoporous. For example, in some embodiments, the porous polymer comprises one or more pores having an average characteristic dimension (e.g., an average diameter) greater than or equal to 2 nm.

In some embodiments, the porous polymer is at least partially macroporous. For example, in some embodiments, the porous polymer comprises one or more pores having an average characteristic dimension (e.g., an average diameter) greater than or equal to 50 nm.

According to certain embodiments, the porosity of the porous polymer can be characterized by the Brunauer-Emmett-Teller (BET) surface area of the porous polymer. The porous polymer may have any of a variety of suitable BET surface areas. In some embodiments, for example, the porous polymer has a BET surface area greater than or equal to 100 m²/g, greater than or equal to 200 m²/g, greater than or equal to 300 m²/g, greater than or equal to 400 m²/g, greater than or equal to 500 m²/g, greater than or equal to 600 m²/g, greater than or equal to 700 m²/g, greater than or equal to 800 m²/g, or greater than or equal to 900 m²/g. In certain embodiments, the porous polymer has a BET surface area less than or equal to 1,000 m²/g, less than or equal to 900 m²/g, less than or equal to 800 m²/g, less than or equal to 700 m²/g, less than or equal to 600 m 2 /g, less than or equal to 500 m 2 /g, less than or equal to 400 m 2 /g, less than or equal to 300 m²/g, or less than or equal to 200 m²/g. Combinations of the above recited ranges are possible (e.g., the porous polymer has a BET surface area greater than or equal to 100 m²/g and less than or equal to 1,000 m²/g, the porous polymer has a BET surface area greater than or equal to 400 m²/g and less than or equal to 600 m²/g). Other ranges are also possible. The BET surface area of the porous polymer may be determined by gas absorption isotherm measurements.

In some embodiments, the void space(s) of the porous polymer are transient, and hence defined to a person of ordinary skill in the art as free volume elements. In certain embodiments, the transient void spaces(s) of the porous polymer are permeable to fluids and/or enable transport of molecules, ions, and the like, but do not have a measurable BET surface area.

In accordance with certain embodiments, at least a portion of the plurality of pores are in fluid communication with an exterior environment of the porous polymer.

According to some embodiments, the porous polymer is permeable to fluids (e.g., gases and/or liquids). For example, in some embodiments, the porous polymer is permeable to hydrogen gas and may have any of a variety of suitable hydrogen gas permeabilities. In certain embodiments, the porous polymer has a hydrogen gas permeability at 35° C. and 1 bar greater than or equal to 100 barrer, greater than or equal to 1,000 barrer, greater than or equal to 2,000 barrer, greater than or equal to 5,000 barrer, greater than or equal to 10,000 barrer, greater than or equal to 20,000 barrer, greater than or equal to 50,000 barrer, or greater than or equal to 100,000 barren In some embodiments, the porous polymer has a hydrogen gas permeability at 35° C. and 1 bar less than or equal to 200,000 barrer, less than or equal to 100,000 barrer, less than or equal to 50,000 barrer, less than or equal to 20,000 barrer, less than or equal to 10,000 barrer, less than or equal to 5,000 barrer, less than or equal to 2,000 barrer, or less than or equal to 1,000 barrer. Combinations of the above recited ranges are possible (e.g., the porous polymer has a hydrogen gas permeability at 35° C. and 1 bar greater than or equal to 100 barrer and less than or equal to 200,000 barrer, the porous polymer has a hydrogen gas permeability at 35° C. and 1 bar greater than or equal to 10,000 barrer and less than or equal to 20,000 barrer). Other ranges are also possible. In certain embodiments, the hydrogen gas permeability of the porous polymer is determined by measuring the molar flux of hydrogen gas through a film of the porous polymer of known thickness and surface area with a known pressure on one side of the film and a vacuum on the other side of the film.

As would generally be understood by a person of ordinary skill in the art, the porous polymer may, in some embodiments, be permeable to other fluids (e.g., gases and/or liquids) in addition to hydrogen gas, as described elsewhere herein in greater detail.

According to some embodiments, the porous polymer is stiff, rigid, and/or has a relatively high modulus (e.g., as compared to conventional porous polymers). In certain embodiments, for example, the porous polymer lacks segmental motion of its polymer chains unless the porous polymer is heated above its glass transition temperature (T_{g}). As used herein, the term “glass transition temperature” is given its ordinary meaning in the art and refers to the temperature at which an amorphous polymer changes from a hard and relatively brittle “glassy” state to a viscous or rubbery state.

The porous polymer may have any of a variety of suitable glass transition temperatures. In some embodiments, for example, the porous polymer has a glass transition temperature above room temperature (RT) (e.g., 15-25° C.). In certain embodiments, the porous polymer has a glass transition temperature greater than or equal to 200° C., greater than or equal to 250° C., greater than or equal to 300° C., greater than or equal to 350° C., or greater than or equal to 400° C. In some embodiments, the porous polymer has a glass transition temperature less than or equal to 450° C., less than or equal to 400° C., less than or equal to 350° C., less than or equal to 300° C., or less than or equal to 250° C. Combinations of the above recited ranges are possible (e.g., the porous polymer has a glass transition temperature greater than or equal to 200° C. and less than or equal to 450° C., the porous polymer has a glass transition temperature greater than or equal to 300° C. and less than or equal to 350° C.). Other ranges are also possible. According to some embodiments, the glass transition temperature of the porous polymer is higher than the decomposition temperature of the porous polymer, and as a result the glass transition temperature of the porous polymer may not be readily determined. In certain embodiments wherein the glass transition of the porous polymer is lower than the decomposition temperature of the porous polymer, the glass transition temperature of the porous polymer may be determined by differential scanning calorimetry, dynamic mechanical analysis, and/or by measurements of the coefficient of thermal expansion of the porous polymer as a function of temperature.

According to certain embodiments, the porous polymer is or comprises a poly(arylene ether). In certain embodiments, for example, the porous polymer is or comprises a structure of the formula [(—Ar—O—Ar′—O—)ₙ]. The formula [(—Ar—O—Ar′—O—)ₙ] may, in certain embodiments, represent the entire material or a subunit of a larger structure.

In some embodiments, the porous polymer has a linear connectivity and may be considered a linear, unbranched polymer. In other embodiments, the porous polymer comprises one or more branching groups and may be considered a branched polymer. As used herein, the term “branched polymer” is given its ordinary meaning in the art and refers to a polymer having one or more secondary polymer chains associated with (e.g., bonded to) a primary backbone. The one or more branching groups may, in some embodiments, have two or more sites capable of reactivity for association with a repeating unit of the porous polymer.

In certain embodiments, the porous polymer is a hyperbranched polymer. As used herein, the term “hyperbranched polymer” is given its ordinary meaning in the art and refers to a dendritic polymer having a high branching density with the potential of branching in each repeating unit of the porous polymer.

In certain embodiments, Ar in the formula [(—Ar—O—Ar′—O—)ₙ] comprises at least one aryl group (e.g., one aryl group, two aryl groups, three aryl groups, four aryl groups, etc.) and/or at least one heteroaryl group (e.g., one heteroaryl group, two heteroaryl groups, three heteroaryl groups, four heteroaryl groups, etc.). As used herein, the term “aryl” is given its ordinary meaning in the art and refers to single-ring, multiple-ring, or multiple-fused-ring aromatic groups. In some embodiments, the single-ring, multiple-ring, or multiple-fused-ring aromatic groups comprise, for example, 5-, 6- and 7-membered ring aromatic groups, all of which may be optionally substituted. The term “heteroaryl” is also given its ordinary meaning in the art and refers to an aryl group as described herein in which one or more atoms is a heteroatom (e.g., a phosphorus atom, an oxygen atom, a nitrogen atom, a sulfur atom, and the like).

In some embodiments, Ar in the formula [(—Ar—O—Ar′—O—)ₙ] comprises one or more of a benzene group, a phenanthrene group, an iptycene group (e.g., a triptycene group, a pentiptycene group), a spirobis(indene) group, a fluorene group, a benzophenone group, a biphenyl group (e.g., a spiro-biphenyl group, a bridged biphenyl group), a binaphthyl group, a pyrene group, an anthracene group, a triphenylene group, a pyrazine group, an indole group, a thiophene group, a bithiophene group, a pyrrole group, an oligophenylene group, a stilbene group, a diphenyl acetylene group, an anthraquinone group, a metallocene group, a spirobifluorene group, a pyridine group, a bipyridine group, a phenanthroline group, and/or a diphenyl sulfone group, any of which may be optionally substituted (e.g., with one or more functional groups). Other aryl groups are also possible. In some embodiments, the one or more functional groups comprise an aliphatic group (e.g., a methyl group, an ethyl group, a propyl group, a butyl group, an alkene, an alkyne), a nitrile group (—C≡N), an amine group (e.g., a primary amine, a secondary amine, a tertiary amine), an aldehyde group, a fluorine group, and/or combinations thereof.

In certain embodiments, Ar in the formula [(—Ar—O—Ar′—O—)ₙ] comprises one or more cyclic groups and/or heterocyclic groups. For example, in some embodiments, Ar comprises one or more of a cyclopentane group, a bicyclic group and/or ring structure (e.g., a [2.2.1] bicyclic group and/or ring structure, a [2.2.2] bicyclic group and/or ring structure, a [2.2.3] bicyclic group and/or ring structure, a [2.3.1] bicyclic group and/or ring structure), a polycyclic group and/or ring structure, a diazole group, and/or an oxadiazole group, any of which may be optionally substituted (e.g., with one or more functional groups). Other cyclic groups are also possible.

In some non-limiting embodiments, Ar in the formula [(—Ar—O—Ar′—O—)ₙ] comprises an iptycene group (e.g., a triptycene group, a pentiptycene group). The iptycene group may be optionally substituted, in some embodiments, with one or more functional groups.

According to some embodiments, Ar′ in the formula [(—Ar—O—Ar′—O—)ₙ] comprises at least one aryl group (e.g., one aryl group, two aryl groups, three aryl groups, four aryl groups, etc.) and/or at least one heteroaryl group (e.g., one heteroaryl group, two heteroaryl groups, three heteroaryl groups, four heteroaryl groups, etc.). In certain embodiments, for example, Ar′ comprises one or more of a benzene group, a phenanthrene group, an iptycene group (e.g., a triptycene group, a pentiptycene group), a spirobis(indene) group, a fluorene group, a benzophenone group, a biphenyl group (e.g., a spiro-biphenyl group, a bridged biphenyl group), a binaphthyl group, a pyrene group, an anthracene group, a triphenylene group, a pyrazine group, an indole group, a thiophene group, a bithiophene group, a pyrrole group, an oligophenylene group, a stilbene group, a diphenyl acetylene group, an anthraquinone group, a metallocene group, a spirobifluorene group, a pyridine group, a bipyridine group, a phenanthroline group, and/or a diphenyl sulfone group, any of which may be optionally substituted (e.g., with one or more functional groups). Other aryl groups are also possible. In some embodiments, the one or more functional groups may comprise an aliphatic group (e.g., a methyl group, an ethyl group, a propyl group, a butyl group, an alkene, an alkyne), a nitrile group, an amine group (e.g., a primary amine, a secondary amine, a tertiary amine), an aldehyde group, a fluorine group, and/or combinations thereof.

According to certain embodiments, Ar′ in the formula [(—Ar—O—Ar′—O—)ₙ] comprises one or more cyclic groups and/or heterocyclic groups. In some embodiments, for example, Ar′ comprises one or more of a cyclopentane group, a bicyclic group and/or ring structure (e.g., a [2.2.1] bicyclic group and/or ring structure, a [2.2.2] bicyclic group and/or ring structure, a [2.2.3] bicyclic group and/or ring structure, a [2.3.1] bicyclic group and/or ring structure), a polycyclic group and/or ring structure, a diazole group, and/or an oxadiazole group, any of which may be optionally substituted (e.g., with one or more functional groups). Other cyclic groups are also possible.

In some non-limiting embodiments, Ar′ in the formula [(—Ar—O—Ar′—O—)ₙ] comprises a diphenyl sulfone group, a biphenyl group, a diazole group, and/or an oxadiazole group. The diphenyl sulfone group, biphenyl group, diazole group, and/or oxadiazole group may, in certain embodiments, be optionally substituted with one or more functional groups.

The value of “n” in the formula [(—Ar—O—Ar′—O—)ₙ] may be any of a variety of suitable values. In certain embodiments, for example, n is greater than or equal to 1, greater than or equal to 2, greater than or equal to 5, greater than or equal to 10, greater than or equal to 50, greater than or equal to 100, greater than or equal to 500, greater than or equal to 1,000, or greater than or equal to 5,000. In some embodiments, n is less than or equal to 10,000, less than or equal to 5,000, less than or equal to 1,000, less than or equal to 500, less than or equal to 100, less than or equal to 50, less than or equal to 10, less than or equal to 5, or less than or equal to 2. Combinations of the above recited ranges are possible (e.g., the value of n is greater than or equal to 1 and less than or equal to 10,000, the value of n is greater than or equal to 100 and less than or equal to 1,000). Other ranges are also possible.

The porous polymer may have any of a variety of suitable molecular weights (e.g., number-average molecular weights). In certain embodiments, for example, the porous polymer has a number-average molecular weight greater than or equal to 500 g/mol, greater than or equal to 1,000 g/mol, greater than or equal to 5,000 g/mol, greater than or equal to 10,000 g/mol, greater than or equal to 50,000 g/mol, greater than or equal to 100,000 g/mol, greater than or equal to 500,000 g/mol, greater than or equal to 1,000,000 g/mol, or greater than or equal to 1,500,000 g/mol. In some embodiments, the porous polymer has a number-average molecular weight less than or equal to 2,000,000 g/mol, less than or equal to 1,500,000 g/mol, less than or equal to 1,000,000 g/mol, less than or equal to 500,000 g/mol, less than or equal to 100,000 g/mol, less than or equal to 50,000 g/mol, less than or equal to 10,000 g/mol, less than or equal to 5,000 g/mol, or less than or equal to 1,000 g/mol. Combination of the above recited ranges are possible (e.g., the porous polymer has a number-average molecular weight greater than or equal to 500 g/mol and less than or equal to 2,000,000 g/mol, the porous polymer has a number-average molecular weight between greater than or equal to 50,000 g/mol and less than or equal to 100,000 g/mol). Other ranges are also possible. The molecular weight (e.g., the number-average molecular weight) of the porous polymer may be determined by gel permeation chromatography.

According to certain embodiments, the porous polymer comprises one or more metal interaction sites. In some embodiments, for example, the porous polymer comprises one or more P atoms, N atoms, S atoms, O atoms, and/or combinations thereof. Other metal interaction sites are also possible. In certain embodiments, the one or more metal interactions sites are capable of interacting with one or more metals. Interactions between the metal interaction sites and one or more metals are described elsewhere herein in greater detail.

In some embodiments, the porous polymer comprises one or more ionic groups. According to certain embodiments, the one or more ionic groups are configured for ion exchange reactions with metal ions that are used to produce the metal nanoparticles. In certain embodiments, the porous polymer comprises a sulfate group, an ammonium group, and/or combinations thereof. Other ionic groups are also possible.

According to certain embodiments, the porous polymer is or comprises a compound selected from the group consisting of:

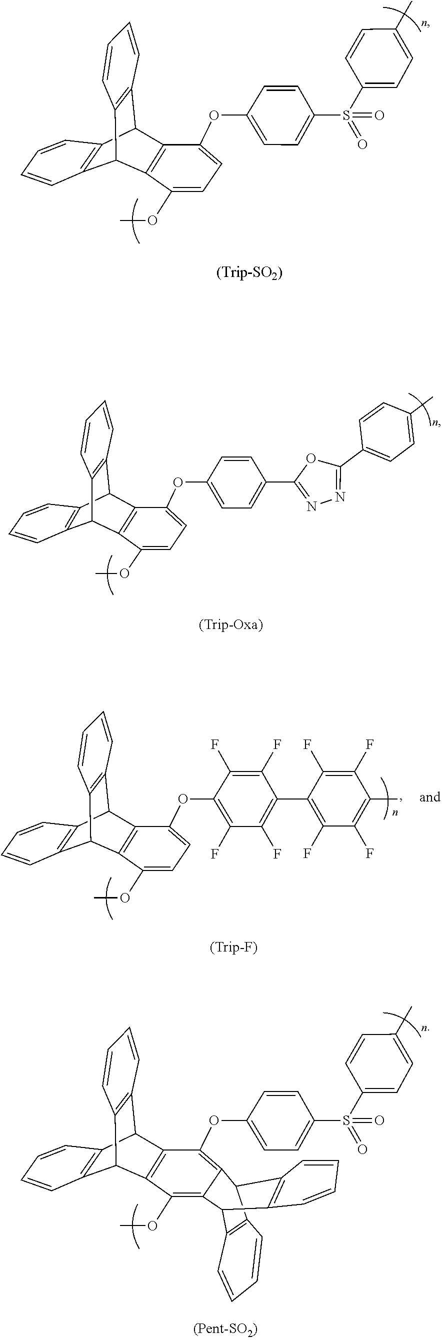

The value of “n” in the structures shown above may be any of a variety of suitable values. In some embodiments, for example, the value of “n” is greater than or equal to 1 and less than or equal to 10,000, as described herein with respect to the formula [(—Ar—O—Ar′—O—)ₙ].

Methods of synthesizing the porous polymer are described in greater detail in U.S. application Ser. No. 17/357,252, filed Jun. 24, 2021, and entitled “Poly(aryl ether) Based Polymers and Associated Gas Separation Membranes”, and in U.S. application Ser. No. 17/560,983, filed Dec. 23, 2021, and entitled “Poly(aryl ether) Based Polymers and Associated Methods”, both of which are incorporated herein by reference in their entirety for all purposes.

According to certain embodiments, the composition comprises metal nanoparticles. The term “nanoparticle” is used herein in a manner consistent with its ordinary meaning in the art and refers to particles with a maximum characteristic dimension (e.g., a maximum diameter) from 1 nm to 1 micrometer. In some embodiments, the metal nanoparticles are sensing metal nanoparticles. In certain embodiments, for example, the metal nanoparticles are configured such that an electronic state (e.g., electronic valence state) of at least a portion of the metal nanoparticles changes upon exposure to hydrogen gas. As described herein in greater detail, in some embodiments, the change in the electronic state of at least the portion of the metal nanoparticles upon exposure to hydrogen gas may advantageously be determined to detect hydrogen gas at low concentration.

According to some embodiments, the metal nanoparticles are relatively small (e.g., as compared to conventional metal nanoparticles used in sensing applications). In some embodiments, metal nanoparticles having a sufficiently small size may advantageously provide the metal nanoparticles with an increased surface area that is available for exposure to hydrogen gas. For example, without wishing to be bound by any particular theory, smaller nanoparticles having a high ratio of reactive surface metal atoms to non-surface atoms can provide enhanced sensitivity to hydrogen.

The metal nanoparticles may have any of a variety of suitable average characteristic dimensions (e.g., average diameters). In some embodiments, for example, the metal nanoparticles have an average characteristic dimension greater than or equal to 1 nm, greater than or equal to 2 nm, greater than or equal to 3 nm, greater than or equal to 4 nm, greater than or equal to 5 nm, greater than or equal to 6 nm, greater than or equal to 7 nm, greater than or equal to 8 nm, or greater than or equal to 9 nm. In certain embodiments, the metal nanoparticles have an average characteristic dimension less than or equal to 10 nm, less than or equal to 9 nm, less than or equal to 8 nm, less than or equal to 7 nm, less than or equal to 6 nm, less than or equal to 5 nm, less than or equal to 4 nm, less than or equal to 3 nm, or less than or equal to 2 nm. Combinations of the above recited ranges are possible (e.g., the metal nanoparticles have an average characteristic dimension greater than or equal to 1 nm and less than or equal to 10 nm, the metal nanoparticles have an average characteristic dimension greater than or equal to 4 nm and less than or equal to 6 nm). Other ranges are also possible. The average characteristic dimension of the metal nanoparticles may be determined by microscopy techniques (e.g., scanning electron microscopy and/or transmission electron microscopy).

The metal nanoparticles may comprise any of a variety of suitable metals. In some embodiments, the metal nanoparticles comprise palladium (Pd), gold (Au), silver (Ag), copper (Cu), nickel (Ni), cobalt (Co), iridium (Ir), rhodium (Rh), platinum (Pt), alloys thereof, and/or combinations thereof. Other metals, including, for example, tin (Sn), lead (Pb), and bismuth (Bi), are also possible.

In certain non-limiting embodiments, the metal nanoparticles comprise palladium. The metal nanoparticles may comprise palladium in any of a variety of suitable amounts. In certain embodiments, for example, at least one metal nanoparticle comprises palladium in an amount greater than or equal to 1 weight percent (wt. %), greater than or equal to 10 wt. %, greater than or equal to 20 wt. %, greater than or equal to 30 wt. %, greater than or equal to 40 wt. %, greater than or equal to 50 wt. %, greater than or equal to 60 wt. %, greater than or equal to 70 wt. %, greater than or equal to 80 wt. %, or greater than or equal to 90 wt. % versus the total weight of the at least one metal nanoparticle. In some embodiments, at least one metal nanoparticle comprises palladium in an amount less than or equal to 99 wt. %, less than or equal to 90 wt. %, less than or equal to 80 wt. %, less than or equal to 70 wt. %, less than or equal to 60 wt. %, less than or equal to 50 wt. %, less than or equal to 40 wt. %, less than or equal to 30 wt. %, less than or equal to 20 wt. %, or less than or equal to 10 wt. % versus the total weight of the at least one metal nanoparticle. Combinations of the above recited ranges are possible (e.g., at least one metal nanoparticle comprises palladium in an amount greater than or equal to 1 wt. % and less than or equal to 99 wt. % versus the total weight of the at least one metal nanoparticle, at least one metal nanoparticle comprises palladium in an amount greater than or equal to 40 wt. % and less than or equal 60 wt. % versus a total weight of the at least one metal nanoparticle). Other ranges are also possible.

In some embodiments, the metal nanoparticles comprise one or more heteroatoms. For example, in certain embodiments, the metal nanoparticles comprise fluorine (F), chlorine (Cl), bromine (Br), sulfur (S), oxygen (O), nitrogen (N), silicon (Si), phosphorus (P), and/or combinations thereof. Other heteroatoms are also possible.

In some embodiments, the metal nanoparticles comprise a mixture of metals and/or a mixture of heteroatoms. In certain embodiments, employing metal nanoparticles that comprise a mixture of metals and/or a mixture of heteroatoms may advantageously increase a rate of reaction with hydrogen gas and/or prevent irreversible reactions with one or more interfering species (e.g., one or more gases other than the hydrogen gas).

According to certain embodiments, the metal nanoparticles comprise a neutral metal (i.e., in a valence oxidation state of 0). As described elsewhere herein in greater detail, the metal nanoparticles comprising a neutral metal (i.e., in a valence oxidation state of 0) may be configured to be oxidized by the absorption of hydrogen upon exposure to hydrogen gas. In some embodiments, for example, the metal nanoparticles comprising a neutral metal are configured to form a metal-hydride upon exposure to hydrogen gas.

In some embodiments, the metal nanoparticles comprise an oxidized metal. For example, in certain embodiments, the metal nanoparticles comprise a metal in a valence oxidation state of +1, +2, +3, and/or +4. As described elsewhere herein in greater detail, the metal nanoparticles comprising an oxidized metal (e.g., in a valence oxidation state of +1, +2, +3, and/or +4) may be configured to be reduced by hydrogen upon exposure to hydrogen gas. The oxidized metal may have any of a variety of suitable forms. In some embodiments, for example, the oxidized metal is a metal oxide. Other oxidized metals are also possible.

According to some embodiments, the metal nanoparticles comprise a mixture of a neutral metal (e.g., in a valence oxidation state of 0) and an oxidized metal (e.g., in a valence oxidation state of +1, +2, +3, and/or +4). In certain embodiments, for example, the metal nanoparticles comprise a neutral metal core at least partially surrounded by an oxidized metal shell. In some embodiments, the metal nanoparticles comprise a neutral metal and an oxidized metal distributed relatively uniformly throughout the metal nanoparticles. In certain embodiments, the metal nanoparticles comprise an oxidized metal and a neutral metal distributed relatively uniformly throughout the metal nanoparticles.

According to certain embodiments, the metal nanoparticles are contained within the porous polymer. For example, in some embodiments, the metal nanoparticles are contained within the plurality of pores. Without wishing to be bound by any particular theory, it may be advantageous, in some embodiments to contain the metal nanoparticles within the porous polymer (e.g., within the plurality of pores) to avoid agglomeration and/or Ostwald ripening of the metal nanoparticles. In certain embodiments, for example, containing the meal nanoparticles within the porous polymer (e.g., within the plurality of pores) comprises constraining the metal nanoparticles within the porous polymer (e.g., within the plurality of pores). In some embodiments, containing the metal nanoparticles within the porous polymer advantageously allows the metal nanoparticles to retain a sufficiently small size (e.g., an average characteristic dimension greater than or equal to 1 nm and less than or equal to 10 nm) and therefore an increased surface area available for exposure to hydrogen gas.

In some embodiments, the average characteristic dimension (e.g., the average diameter) of the metal nanoparticles is smaller than the average characteristic dimension (e.g., the average diameter) of the plurality of pores. In certain embodiments, the average characteristic dimension (e.g., the average diameter) of the metal nanoparticles is the same as the average characteristic dimension (e.g., the average diameter) of the plurality of pores.

According to some embodiments, a certain percentage of a surface area of each metal nanoparticle is exposed to one or more pores of the plurality of pores. In certain embodiments, for example, at least 25%, at least 50%, at least 60%, at least 70%, at least 80%, at least 90%, or at least 99% of the surface area of each metal nanoparticle is exposed to one or more pores of the plurality of pores. In some embodiments, less than or equal to 100%, less than or equal to 99%, less than or equal to 80%, less than or equal to 70%, less than or equal to 60%, or less than or equal to 50% of the surface area of each metal nanoparticle is exposed to one or more pores of the plurality of pores. Combinations of the above recited ranges are possible (e.g., at least 25% and less than or equal to 100% of the surface area of each metal nanoparticle is exposed to one or more pores of the plurality of pores, at least 60% and less than or equal to 70% of the surface area of each metal nanoparticle is exposed to one or more pores of the plurality of pores).

In certain embodiments, at least a portion of the metal nanoparticles are immobilized within the porous polymer (e.g., within the plurality of pores). For example, in some embodiments, at least 50%, at least 60%, at least 70%, at least 80%, at least 90% or at least 99% of the metal nanoparticles are immobilized within the porous polymer. In certain embodiments, less than or equal to 100%, less than or equal to 99%, less than or equal to 90%, less than or equal to 80%, less than or equal to 70%, or less than or equal to 60% of the metal nanoparticles are immobilized within the porous polymer. Combinations of the above recited ranges are possible (e.g., at least 50% and less than or equal to 100% of the metal nanoparticles are immobilized within the porous polymer, at least 60% and less than or equal to 70% of the metal nanoparticles are immobilized within the porous polymer).

As described in greater detail elsewhere herein, the porous polymer may comprise one or more metal interaction sites (e.g., one or more P atoms, N atoms, S atoms, O atoms, and/or combinations thereof that are capable of interacting with one or more metals). In some such embodiments, at least a portion of the metal nanoparticles may interact with the one or more metal interaction sites. In some embodiments, for example, at least a portion of the metal nanoparticles are bound (e.g., chemically bound) to the one more metal interaction sites. Any of a variety of suitable interactions and/or bonds between the one or more metal interaction sites and at least the portion of the metal nanoparticles may be possible. In some embodiments, for example, the interaction and/or bond between the one or more metal interaction sites and at least the portion of the metal nanoparticles is a covalent bond, an ionic bond, a van der Waals interaction, a hydrogen bond, a dipole interaction, a coordination interaction, a chelation interaction, and/or the like. Advantageously, the one or more metal interaction sates may, in some embodiments, stabilize and/or nucleate the metal nanoparticles.

As described in greater detail elsewhere herein, the porous polymer may have a porosity as characterized by a BET surface area of, e.g., greater than or equal to 100 m²/g and less than or equal to 1,000 m²/g. In certain embodiments, the porosity of the porous polymer allows diffusion of one or more gases (e.g., hydrogen gas) to a certain percentage of the metal nanoparticles contained within the porous polymer. For example, in some embodiments, the porosity of the porous polymer allows diffusion of one or more gases to at least 25%, at least 50%, at least 60%, at least 70%, at least 80%, at least 90%, or at least 99% of the metal nanoparticles contained within the porous polymer. In certain embodiments, the porosity of the porous polymer allows diffusion of one or more gases to less than or equal to 100%, less than or equal to 99%, less than or equal to 90%, less than or equal to 80%, less than or equal to 70%, less than or equal to 60%, or less than or equal to 50% of the metal nanoparticles contained within the porous polymer. Combinations of the above recited ranges are possible (e.g., the porosity of the porous polymer allows diffusion or one or more gases to at least 25% and less than or equal to 100% of the metal nanoparticles contained within the porous polymer, the porosity of the porous polymer allows diffusion of one or more gases to at least 50% and less than or equal to 60% of the metal nanoparticles contained within the porous polymer).

According to certain embodiments, the composition may comprise additional metal particles that are not sensing metal nanoparticles, such that an electronic state of the additional metal particles does not change upon exposure to hydrogen gas.

According to certain embodiments, the metal nanoparticles contained within the porous polymer are formed by chemical reduction. For example, in some embodiments, the metal nanoparticles contained within the porous polymer are formed by reducing a metal salt in the presence of the porous polymer. In some embodiments, a reducing agent is used to the reduce the metal salt. In some embodiments, the porous polymer and the metal salt are suspended and/or dissolved in solution and the reducing agent is added to the solution to reduce the metal salt, thereby forming the metal nanoparticles contained within the porous polymer. In other embodiments, a film of the porous polymer is impregnated with the metal salt, which is then exposed to the reducing agent to reduce the metal salt, thereby forming the metal nanoparticles contained within the porous polymer. Any of a variety of suitable reducing agents may be utilized, including, but not limited to, sodium borohydride, amines, hydrazine, hydrogen, alkenes, alkynes, and/or alcohols.

In some embodiments, the metal nanoparticles contained within the porous polymer are formed by electrochemical reduction. For example, in certain embodiments, the porous polymer and the metal salt are suspended and/or dissolved in solution, and an electrical potential is applied to reduce the metal salt, thereby forming the metal nanoparticles contained within the porous polymer.

According to certain embodiments, the metal nanoparticles contained within the porous polymer are formed by photochemical reduction. For example, in certain embodiments, a film of the porous polymer is impregnated with the metal salt, which is then exposed to ultraviolet and/or visible light irradiation to reduce the metal salt, thereby forming the metal nanoparticles containing within the porous polymer.

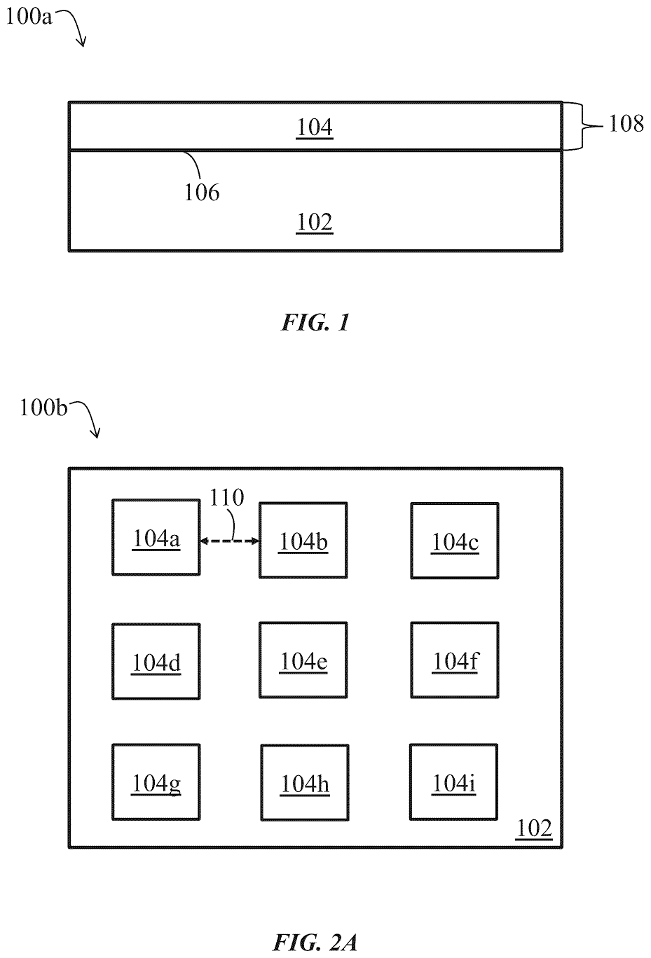

According to certain embodiments, an article is described. FIG. 1 is, in accordance with certain embodiments, a cross-sectional schematic diagram of article 100a. In some embodiments, the article comprises a substrate and a composition disposed on at least a portion of the substrate. Referring, for example, to FIG. 1, article 100a comprises substrate 102 and composition 104 disposed on at least a portion of substrate 102. The composition may, in some embodiments, comprise a porous polymer and metal nanoparticles contained within the porous polymer, as described elsewhere herein in greater detail.

In some embodiments, the composition is disposed on at least a portion of at least one surface of the substrate such that the composition coats at least the portion of the at least one surface of the substrate. For example, referring to FIG. 1, composition 104 is disposed on at least a portion of at least one surface 106 of substrate 102 such that composition 104 coats at least the portion of at least one surface 106 of substrate 102.

The composition disposed on at least the portion of the substrate may have any of a variety of suitable thicknesses. Referring to FIG. 1, for example, composition 104 disposed on at least the portion of substrate 102 may have thickness 108a. In some embodiments, the composition disposed on at least the portion of the substrate has an average thickness greater than or equal to 10 nm, greater than or equal to 20 nm, greater than or equal to 50 nm, greater than or equal to 100 nm, greater than or equal to 200 nm, greater than or equal to 500 nm, greater than or equal to 1 micrometer, greater than or equal to 2 micrometers, greater than or equal to 5 micrometers, greater than or equal to 10 micrometers, greater than or equal to 20 micrometers, greater than or equal to 50 micrometers, greater than or equal to 100 micrometers, greater than or equal to 200 micrometers, greater than or equal to 500 micrometers, or greater than or equal to 1 mm. In some embodiments, the composition disposed on at least the portion of the substrate has an average thickness less than or equal to 10 mm, less than or equal to 1 mm, less than or equal to 500 micrometers, less than or equal to 200 micrometers, less than or equal to 100 micrometers, less than or equal to 50 micrometers, less than or equal to 20 micrometers, less than or equal to 10 micrometers, less than or equal to 5 micrometers, less than or equal to 2 micrometers, less than or equal to 1 micrometer, less than or equal to 500 nm, less than or equal to 200 nm, less than or equal to 100 nm, less than or equal to 50 nm, or less than or equal to 20 nm. Combinations of the above recited ranges are possible (e.g., the composition disposed on at least the portion of the substrate has an average thickness greater than or equal to 10 nm and less than or equal to 10 mm, the composition disposed on at least the portion of the substrate has an average thickness greater than or equal to 1 micrometer and less than or equal to 2 micrometers). Other ranges are also possible. The average thickness of the composition disposed on at least the portion of the substate may be determined by microscopy techniques (e.g., scanning electron microscopy and/or transmission electron microscopy).

Although composition 104 disposed on surface 106 of substrate 102 is depicted in FIG. 1 as a smooth layer of uniform thickness, those of ordinary skill in the art would understand that this is for illustration purposes only and the thickness of the composition disposed on the surface of the substrate may have a particular roughness and/or may vary in thickness, in accordance with some embodiments. In certain embodiments, the composition disposed on the surface of the substrate may be of relatively uniform thickness (e.g., within less than or equal to 10% of the total thickness) over at least a substantial portion of the surface of the substrate (e.g., greater than or equal to 75% of the surface area of the surface of the substrate on which the composition is disposed).

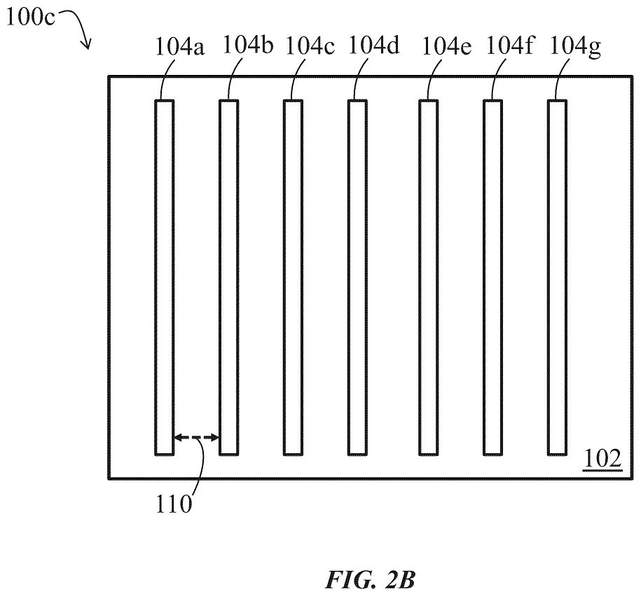

According to some embodiments, the composition is patterned on at least a portion of the substrate. FIG. 2A is, in accordance with certain embodiments, a top-view schematic diagram of article 100b comprising substrate 102 and portions of composition 104 (e.g., 104a-104i) patterned on at least a portion of substrate 102.

Although FIG. 2A shows portions of composition 104 patterned on substrate 102 in a square configuration, those of ordinary skill in the art would understand that this is for illustration purposes only and other configurations are possible, in accordance with some embodiments. In certain embodiments, for example, the portions of the composition patterned on the substrate may have a rectangular configuration, a circular configuration, a hexagonal configuration, and/or any other suitable configuration. In other embodiments, the composition may be patterned on the substrate such that the portions of the composition form lines and/or gratings. FIG. 2B is, in accordance with certain embodiments, a top-view schematic diagram of article 100c comprising substrate 103 and portions of composition 104 (e.g., 104a-104g) patterned on at a least a portion of substrate 102 in the form of lines and/or gratings.

In certain embodiments, the composition may be patterned on at least a portion of the substrate such that portions of the composition have any of a variety of suitable characteristic spacings. As used herein, the characteristic spacing of a patterned composition refers to the shortest distance between a first portion of the composition and a second portion of the composition that is nearest to the first portion of the composition. For example, referring to FIGS. 2A-2B, the characteristic spacing between portion of composition 104a and portion of composition 104b is 110, the shortest distance between portion of composition 104a and portion of composition 104b. According to some embodiments, the average characteristic spacing refers to the number average of the characteristic spacings between the individual portions of the composition.

According to some embodiments, the average characteristic spacing between the portions of the composition, when present, is at least 1 nm, at least 10 nm, at least 50 nm, at least 100 nm, at least 200 nm, at least 300 nm, at least 500 nm, or at least 700 nm. According to some embodiments, the average characteristic spacing between the portions of the composition, when present, is less than or equal to 1 micrometer, less than or equal to 700 nm, less than or equal to 500 nm, less than or equal to 300 nm, less than or equal to 200 nm, less than or equal to 100 nm, less than or equal to 50 nm, or less than or equal to 10 nm. Combinations of the above recited ranges are possible (e.g., the average characteristic spacing between the portions of the composition, when present is at least 1 nm and less than or equal to 1 micrometer, the average characteristic spacing between the portions of the composition, when present, is at least 100 nm and less than or equal to 200 nm). Other ranges are also possible.

The composition may be disposed on the substrate via any of a variety of suitable techniques. In certain embodiments, for example, the composition is drop-casted, spray coated, screen printed, and/or ink jet printed on the substrate. In some embodiments, the composition is disposed on the substrate via nanofabrication methods, such as, but not limited to, lithography (e.g., interference lithography, soft-lithography), electron beam treatment, and/or evaporation through shadow masks. Other methods of disposing the composition on the substrate are also possible.

According to some embodiments, the composition (e.g., disposed on the substrate) may be thermally annealed. In certain embodiments, for example, the composition is thermally annealed at a temperature greater than or equal to 100° C., greater than or equal to 150° C., greater than or equal to 200° C., greater than or equal to 250° C., greater than or equal to 300° C., greater than or equal to 350° C., or greater than or equal to 400° C. In some embodiments, the composition is thermally annealed at a temperature less than or equal to 450° C., less than or equal to 400° C., less than or equal to 350° C., less than or equal to 300° C., less than or equal to 250° C., less than or equal to 200° C., or less than or equal to 150° C. Combinations of the above recited ranges are possible (e.g., the composition is thermally annealed at a temperature greater than or equal to 100° C. and less than or equal to 450° C., the composition is thermally annealed at a temperature greater than or equal to 200° C. and less than or equal to 300° C.). Other ranges are also possible. In certain embodiments, the temperature at which the composition is thermally annealed depends on the glass transition temperature of the porous polymer. Without wishing to be bound by any particular theory, thermally annealing the composition advantageously increases the sensitivity of the composition to hydrogen gas. In certain embodiments, for example, thermally annealing the composition may increase an amount of metal nanoparticles in an oxidized valence state that are configured to be reduced upon exposure to hydrogen gas.

As described elsewhere herein in greater detail, the substrate may be an electrical device (e.g., sensor) that is responsive to a change in an electronic state of the metal nanoparticles, in accordance with some embodiments. In certain embodiments, the substrate may be an optical device (e.g., an optical sensor) that is responsive to a change in an electronic state of the metal nanoparticles.

The substrate may comprise any of a variety of suitable materials. In some embodiments, the substrate comprises an electrically conductive material and/or a chemiresistive material. For example, in certain embodiments, the substrate comprises carbon. Suitable carbon materials include, but are not limited to, carbon nanotubes, such as single-walled carbon nanotubes (SWCNTs), graphene, graphite, and/or combinations thereof. Other carbon materials are also possible. In some embodiments, the substrate comprises a conducting polymer. Suitable conducting polymers include, but are not limited to, polyacetylene, polyaniline, polypyrrole, polythiophene, poly(para-phenylene) poly(phenylenevinylene), polyfuran, and/or combinations thereof. Other conducting polymers are also possible. In some embodiments, the substrate comprises an oxide (e.g., a metal oxide). Suitable oxides include, but are not limited to, tin(IV) oxide (SnO₂), tungsten(VI) oxide (WO₃), molybdenum trioxide (MoO₃), indium(III) oxide (In₂O₃), and/or combinations thereof. Other oxides are also possible.

According to certain embodiments wherein the substrate comprises carbon nanotubes (e.g., single-walled carbon nanotubes), the carbon nanotubes may be purified and/or sorted before being implemented as the substrate. In some embodiments, purifying and/or sorting the carbon nanotubes before implementing them as the substrate may advantageously improve the chemiresistive response of the carbon nanotubes. In certain embodiments, the carbon nanotubes are purified by a diameter-selective dispersion method using one or more polymers. In some embodiments, the polymers are poly(p-phenylene ethynylene)s.

In some embodiments, the substrate comprises glass, a ceramic, paper, or a synthetic polymer.

According to certain embodiments, the substrate comprises one or more electrodes. Any of a variety of suitable electrodes are possible and would be known to a person of ordinary skill in the art. In some non-limiting embodiments, for example, the substrate comprises titanium, gold, and/or graphite electrodes.

According to some embodiments, the substrate comprises a dielectric material. In some embodiments, for example, the substrate comprises an oxide (e.g., aluminum oxide).

In certain embodiments, the substrate comprises a single layer. In other embodiments, the substrate comprises more than one layer (e.g., two layers, three layers, four layers, five layers, etc.). In some embodiments, for example, the substrate may comprise one or more electrode layer and/or one or more dielectric layers.

According to some embodiments, the substrate comprises a transistor. In certain embodiments, for example, the substrate comprises a graphene field-effect transistor (GFET).

In certain embodiments, the substate comprise a waveguide, a microphotonic device, and/or a fiberoptic.

In some embodiments, the article comprising the composition (e.g., the porous polymer and the metal nanoparticles contained within the porous polymer) disposed on at least the portion of the substrate may be a chemiresistor. Referring to FIGS. 1-2B, for example, article 100 (e.g., articles 100a-100c) may be a chemiresistor.

According to certain embodiments, the substrate may comprise and/or be associated with a detector. The detector may be configured to detect a response of the composition (e.g., a change in an electronic state of at least a portion of the metal nanoparticles) upon exposure to hydrogen gas, as described in greater detail elsewhere herein. In some embodiments, the detector is an electrical detector, an optical detector, a spectrometer, or the like.

According to certain embodiments, a method of sensing hydrogen gas is described.

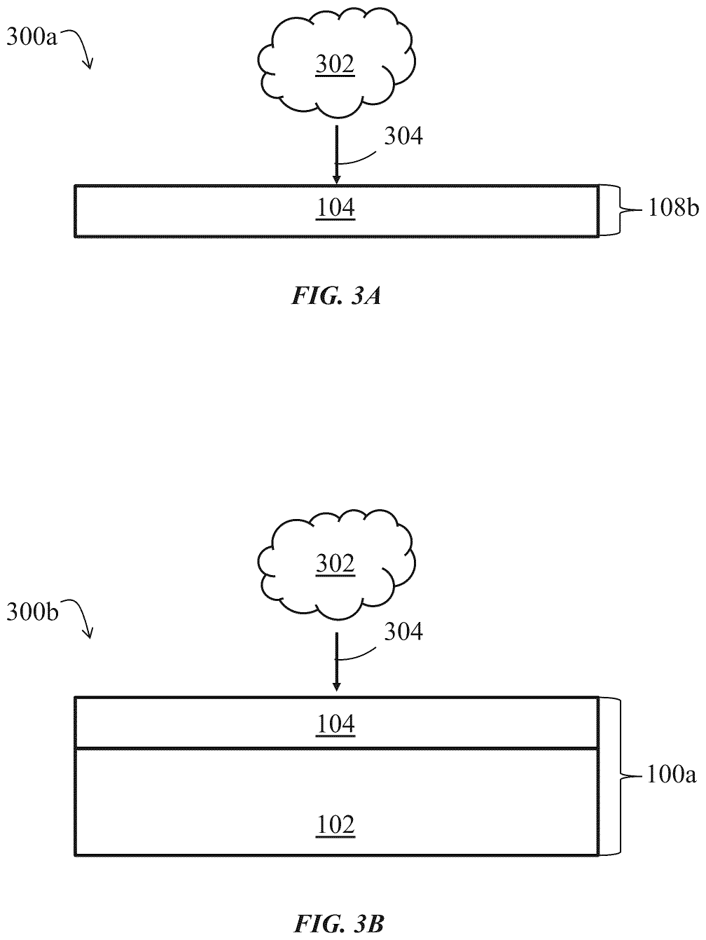

In some embodiments, the method comprises exposing a composition to the hydrogen gas. FIG. 3A is, in accordance with certain embodiments, a cross-sectional schematic diagram representing method 300a of exposing composition 104 to hydrogen gas 302. The composition may, in some embodiments, comprise a porous polymer and metal nanoparticles contained within the porous polymer, as described elsewhere herein in greater detail.

In certain embodiments, the composition that is exposed to the hydrogen gas may be of any of a variety of suitable forms. In some embodiments, for example, the composition is in the form of a thin film. Referring to FIG. 3A, for example, composition 104 is in the form of a thin film.

According to some embodiments, the thin film of the composition may have any of a variety of suitable thicknesses. For example, referring to FIG. 3A, the thin film of composition 104 may have thickness 108b. In some embodiments, the thickness of the thin film of the composition may be the same as thickness 108a as described herein in greater detail with respect to FIG. 1. In some embodiments, for example, the thickness of the thin film of the composition is greater than or equal to 10 nm and less than or equal to 1 mm.

In accordance with certain embodiments, the composition that is exposed to the hydrogen gas may be disposed on a substrate. In some embodiments, for example, the composition is disposed on an electrical and/or optical device (e.g., sensor) that is responsive to a change in an electronic state of the metal nanoparticles. FIG. 3B is, in accordance with certain embodiments, a cross-sectional schematic diagram representing method 300b of exposing composition 104 disposed on substrate 102 to hydrogen gas 302.

According to certain embodiments, exposing the composition to the hydrogen gas comprises flowing the hydrogen gas in a direction such that the hydrogen gas contacts the composition. Referring to FIGS. 3A-3B, for example, exposing composition 104 to hydrogen gas 302 comprises flowing hydrogen gas 302 in direction 304 such that hydrogen gas 302 contacts composition 104. In some embodiments, the hydrogen gas contacts the composition such that the hydrogen gas diffuses into one or more pores of the porous polymer. In certain embodiments, the hydrogen gas that diffuses into the one or more pores of the porous polymer may contact the metal nanoparticles contained within the porous polymer (e.g., contained within the plurality of pores).

Although FIGS. 3A-3B show flowing hydrogen gas 302 in direction 304 perpendicular to a surface of composition 104, those of ordinary skill in the art would understand that this is for illustration purposes only and other configurations are possible, in accordance with some embodiments. In certain embodiments, for example, the hydrogen gas may be flowed parallel to a surface of the composition such that the hydrogen gas flows along the surface of the composition.

In certain embodiments, exposing the composition to the hydrogen gas comprises exposing the composition to a mixture of gases comprising the hydrogen gas. The mixture of gases, may, in some embodiments, comprise one or more gases that do not interfere with an electronic state of at least a portion of the metal nanoparticles changing upon exposure to the mixture of gases comprising the hydrogen gas. The mixture of gases may comprise any of a variety of suitable gases. In some embodiments, for example, the mixture of gases comprises carbon monoxide (CO), carbon dioxide (CO₂), hydrogen sulfide (H₂S), ethylene (C₂H₄), acetylene (C₂H₂), a NO, gas, water vapor, and/or combinations thereof.

Upon exposure to hydrogen gas, the metal nanoparticles may interact with the hydrogen gas via any of a variety of suitable mechanisms.

In certain embodiments, at least a portion of the metal nanoparticles are in a neutral valence state, and exposing the composition to the hydrogen gas comprises forming a metal-hydride. According to some embodiments, for example, at least a portion of the metal particles comprise a neutral meal (i.e., in an oxidation valence state of 0) that is configured to be oxidized by the absorption of hydrogen upon exposure to hydrogen gas, thereby forming the metal-hydride. According to some embodiments, formation of the metal-hydride may decrease the delocalization of electrons in the metal nanoparticles. The decrease in the delocalization of electrons may, in some embodiments, result in a change in an electrical signal and/or an optical signal of the metal nanoparticles. In certain embodiments, the change in the electrical signal and/or the optical signal of the metal nanoparticles may be detected to determine whether the composition was exposed to hydrogen gas.

In some embodiments, at least a portion of the metal nanoparticles are in an oxidized valence state, and exposing the composition to the hydrogen gas comprises reducing at least the portion of the metal nanoparticles in the oxidized valence state. According to certain embodiments, for example, at least a portion of the metal nanoparticles comprise an oxidized metal (e.g., in an oxidation valence sate of +1, +2, +3, and/or +4) that is configured to be reduced by hydrogen upon exposure to hydrogen gas. In some embodiments, upon reduction of the oxidized metal by hydrogen, delocalized electrons are produced. The production of the delocalized electrons may, in some embodiments, result a change in an electrical signal and/or an optical signal of the metal nanoparticles. In certain embodiments, the change in the electrical signal and/or the optical signal of the metal nanoparticles may be detected to determine whether the composition was exposed to hydrogen gas.

According to certain embodiments, the method comprises determining a response of the composition (e.g., after exposing the composition to the hydrogen gas). In some embodiments, for example, the method comprises determining a change in an electrical signal and/or optical signal of the metal nanoparticles after exposing the composition to the hydrogen gas. In some embodiments, an electrical signal and/or optical signal of the metal nanoparticles before exposing the composition to hydrogen gas may compared to the electrical signal and/or optical signal of the metal nanoparticles after exposing the composition to the hydrogen gas to determine a presence and/or concentration of the hydrogen gas.

In some embodiments, the response of the composition is an electrical response. For example, in some embodiments, the method comprises determining a change in the electrical signal of the metal nanoparticles after exposing the composition to hydrogen gas (e.g., relative to an electrical signal of the metal nanoparticles before exposing the composition to hydrogen gas).

In certain embodiments, the electrical response is a change in a resistance and/or a conductivity of the composition. For example, in some embodiments, the method comprises determining a change in the resistance and/or the conductivity of the metal nanoparticles after exposing the composition to hydrogen gas. As described herein in greater detail with respect to FIG. 3B, the composition that is exposed to the hydrogen gas may be disposed on a substrate (e.g., an electrical device that is responsive to a change in an electronic state of the metal nanoparticles). In some embodiments, the electrical response (e.g., the change in the resistance and/or the conductivity of the metal nanoparticles) may provide a change in an electrical signal of the electrical device.

For example, in certain embodiments wherein at least a portion of the metal nanoparticles are in a neutral state (i.e., in an oxidation valence state of 0), the decrease in the delocalization of electrons upon oxidation of the neutral metal and formation of the metal-hydride upon exposure to hydrogen gas may cause electrons to flow from the substrate to the metal nanoparticles, thereby changing the resistance (e.g., decreasing the resistance) and/or the conductivity (e.g., increasing the conductivity) of the substrate. In some such embodiments, the substrate may comprise an oxide (e.g., a metal oxide). According to some embodiments wherein at least a portion of the metal nanoparticles are in an oxidized valence state (e.g., in an oxidation state of +1, +2, +3, and/or +4), the delocalized electrons produced upon reduction of the oxidized metal by hydrogen upon exposure to hydrogen gas may flow from the metal nanoparticles to the substrate, thereby changing the resistance (e.g., increasing the resistance) and/or the conductivity (e.g., decreasing the conductivity) of the substrate. In some such embodiments, the substrate may comprise carbon and/or a conducting polymer. In some embodiments, the change in the resistance and/or the conductivity of the electrical device may be detected by a detector. The change in the resistance and/or conductivity of the electrical device may, in some embodiments, be used to determine whether the composition was exposed to hydrogen gas. In some embodiments, for example, a resistance and/or conductivity of the electrical device before exposing the composition to hydrogen gas is compared to the resistance and/or conductivity of the electrical device after exposing the composition to the hydrogen gas to determine a presence and/or concentration of the hydrogen gas.

In some embodiments, the response of the composition is an optical response. For example, in some embodiments, the method comprises determining a change in the optical signal of the metal nanoparticles after exposing the composition to hydrogen gas (e.g., relative to an optical signal of the metal nanoparticles before exposing the composition to hydrogen gas).

In certain embodiments, the optical response is a change in a plasmonic resonance of the composition. In some embodiments, for example, the method comprises determining a change in the plasmonic resonance of the composition after exposing the composition to hydrogen gas. As used herein, the term “plasmonic resonance” is given its ordinary meaning in the art and refers to a phenomenon where electrons in a metal-containing layer are excited by photons of incident light with a certain angle of incidence, and then propagate parallel to the metal-containing layer.

In certain embodiments wherein at least a portion of the metal nanoparticles are in a neutral state (i.e., in an oxidation valence state of 0), the decrease in the delocalization of electrons upon oxidation of the neutral metal and formation of the metal-hydride upon exposure to hydrogen gas may cause a change in the plasmonic resonance of the metal nanoparticles. According to some embodiments wherein at least a portion of the metal nanoparticles are in an oxidized state (e.g., in an oxidation valence state of +1, +2, +3, and/or +4), the delocalized electrons produced upon reduction of the oxidized metal by hydrogen upon exposure to hydrogen gas may cause a change in the plasmonic resonance of the metal nanoparticles. In some embodiments, the change in the plasmonic resonance of the metal nanoparticles may be detected by detector. In certain embodiments, the change in plasmonic resonance of the metal nanoparticles may be used to determine whether the composition was exposed to hydrogen gas. In some embodiments, for example, a plasmonic resonance of the metal nanoparticles before exposing the composition to hydrogen gas is compared to the plasmonic resonance of the composition after exposing the composition to the hydrogen gas to determine a presence and/or concentration of the hydrogen gas.

In some embodiments, the optical response is a change in a refractive index of the composition. For example, in certain embodiments, the method comprises determining a change in the refractive index of the composition after exposing the composition to hydrogen gas. As used herein, the term “refractive index” is given its ordinary meaning in the art and refers to a dimensionless number that gives an indication of the light bending ability of an optical medium, which can be used to determine how much a path of light is bent, or refracted, when entering the optical medium.

In certain embodiments wherein at least a portion of the metal nanoparticles are in a neutral state (i.e., in an oxidation valence state of 0), the decrease in the delocalization of electrons upon oxidation of the neutral metal and formation of the metal-hydride upon exposure to hydrogen gas may cause a change in the refractive index of the metal nanoparticles. According to some embodiments wherein at least a portion of the metal nanoparticles are in an oxidized state (e.g., in an oxidation valence state of +1, +2, +3, and/or +4), the delocalized electrons produced upon reduction of the oxidized metal by hydrogen upon exposure to hydrogen gas may cause a change in the refractive index of the metal nanoparticles. In some embodiments, the change in the refractive index of the metal nanoparticles may be detected by a detector. In some embodiments, the change in the refractive index of the metal nanoparticles may be used to determine whether the composition was exposed to hydrogen gas. In some embodiments, for example, a refractive index of the metal nanoparticles before exposing the composition to hydrogen gas is compared to the refractive index of the metal nanoparticles after exposing the composition to the hydrogen gas to determine a presence and/or concentration of the hydrogen gas.

As described herein in greater detail with respect to FIG. 3B, the composition that is exposed to the hydrogen gas may be disposed on a substrate (e.g., an optical device that is responsive to a change in an electronic state of the metal nanoparticles). In some embodiments, the method comprises determining an optical response of the composition (e.g., after exposing to the composition to the hydrogen gas), wherein the optical response provides a change in an optical property of the optical device. In some embodiments, for example, as described above, the plasmonic resonance and/or refractive index of the metal nanoparticles may change upon exposure to hydrogen gas. The change in plasmonic resonance and/or refractive index of the metal nanoparticles may, in some embodiments, change a wavelength of a resonance, create inference, and/or outcouple light traveling within the optical device. In some embodiments, the change in the optical property of the optical device may be detected by detector. In certain embodiments, the change in the optical property of the optical device may be used to determine whether the composition was exposed to hydrogen gas. In some embodiments, for example, an optical property of the optical device before exposing the composition to hydrogen gas is compared to the optical property of the optical device after exposing the composition to the hydrogen gas to determine a presence and/or concentration of the hydrogen gas.

According to certain embodiments, the method comprising determining the hydrogen gas. In some embodiments, determining the hydrogen gas comprises detecting a presence of the hydrogen gas. In certain embodiments, for example, detecting a presence of the hydrogen gas comprises detecting a presence of the hydrogen gas from a mixture of gases. The mixture of gases may comprise any of a variety of suitable gases, including, for example, carbon monoxide, carbon dioxide, hydrogen sulfide, ethylene, acetylene, or NO, compositions.

In certain embodiments, detecting a presence of the hydrogen gas comprises detecting a presence of the hydrogen gas at low concentration. In some embodiments, for example, the concentration of the hydrogen gas may be greater than or equal to 1 ppm, greater than or equal to 100 ppm, greater than or equal to 200 ppm, greater than or equal to 500 ppm, greater than or equal to 1,000 ppm, greater than or equal to 2,000 ppm, greater than or equal to 5,000 ppm, or greater than or equal to 10,000 ppm. In some embodiment, the concentration of the hydrogen gas may be less than or equal to 20,000 ppm, less than or equal to 10,000 ppm, less than or equal to 5,000 ppm, less than or equal to 2,000 ppm, less than or equal to 1,000 ppm, less than or equal to 500 ppm, or less than or equal to 100 ppm. Combinations of the above recited ranges are possible (e.g., the concentration of the hydrogen gas is greater than or equal to 100 ppm and less than or equal 20,000 ppm, the concentration of the hydrogen gas is greater than or equal to 1,000 ppm and less than or equal to 2,000 ppm). Other ranges are also possible.

In some embodiments, detecting a presence of the hydrogen gas comprises detecting a presence of the hydrogen gas at any of a variety of relative humidities (e.g., greater than or equal to 10% and less than or equal to 99% relative humidity, greater than or equal to 20% and less than or equal to 80% relative humidity, greater than or equal to 30% and less than or equal to 70% relative humidity, greater than or equal to 40% and less than or equal to 60% relative humidity).

In some embodiments, determining the hydrogen gas comprises determining an amount of the hydrogen gas. In certain embodiments, for example, the magnitude of the change in the electrical signal and/or the optical signal of the metal nanoparticles after exposing the composition to hydrogen gas may be used to determine the amount of hydrogen gas exposed to the metal nanoparticles.

### Example 1

Hydrogen gas is an attractive energy carrier gas, but is hard to contain and has dangerous combustive properties. Metal nanoparticles have utility in the detection of hydrogen gas. Small metal nanoparticles (e.g., less than or equal to 10 nm in diameter and in some embodiments less than or equal to 5 nm in diameter) can be reactive due to their high surface area and surface reactive groups. There are a variety of compositions of sensing nanoparticles that can have reactivity with hydrogen. For example, nanoparticles having at least one palladium atom have utility in hydrogen detection. The sensing nanoparticles can comprise any of a variety of suitable metals, including, but not limited to, palladium, gold, silver, copper, nickel, cobalt, iridium, rhodium, and/or platinum. Different ratios of one or more metals in a sensing nanoparticle can be used to increase a property of interest, create faster responses to hydrogen gas, or prevent irreversible reactions with other interfering species. It is also possible that other elements can be part of the sensing nanoparticles, and non-limiting examples include fluorine, chlorine, bromine, sulfur, oxygen, nitrogen, silicon, and/or phosphorous. Interfering species can be gaseous molecules that are organic or inorganic in nature and non-limiting examples include carbon monoxide, carbon dioxide, hydrogen sulfide, ethylene, acetylene, or NO, compositions.

The sensing nanoparticles can have different chemical forms. In some cases, for example, the sensing nanoparticles can be partially or completely oxidized to create MO, compositions, wherein M represents a diversity of metals as described above. The oxide could be a surface oxide, or the oxygen atoms can be distributed uniformly throughout the sensing nanoparticle. In some cases, not all the atoms in the sensing nanoparticle will be equally oxidized and the oxygen atoms may be more tightly associated with particular metal ions. The stability and nature of the oxide state of the sensing nanoparticle may depend on the environment, the different elements present, the thermal history, photochemical treatments, and/or chemical treatments. In some embodiments, the oxide forms of the sensing nanoparticles may be electron accepting (e.g., oxidizing) and can be used to affect the state of another material. The electronic states in the oxide forms of the nanoparticles can also be more localized.

Oxidized sensing nanoparticles can be reduced by treatment with hydrogen. In this case, the sensing nanoparticle will lose oxygen. This feature can result in delocalized electrons that will impart new conductive or optical properties. In some embodiments, electrons can be exchanged between the sensing nanoparticles and another material in a way that allows for charge transport. In some embodiments, the delocalized electrons can provide a change in optical signal. In certain embodiments, the sensing nanoparticles will have a plasmonic resonance, wherein light couples strongly with the delocalized electrons. In some embodiments, the plasmonic resonance will result in a color change and the sensing nanoparticles can be used to absorb light. The delocalized electrons in the sensing nanoparticles may also change the refractive index of the sensing nanoparticles, which can be used to create reflections or couple to light in waveguides or fiber optics.

Hydrogen may be incorporated in some of the sensing nanoparticles, in accordance with certain embodiments. For example, in some cases, metal hydride species will be formed, and the hydrogen will disrupt the delocalization of the electrons in the sensing nanoparticles. This disruption may produce a change in the optical properties of the sensing nanoparticles, e.g., by decreasing the plasmon resonances and lowering the refractive index relative to the unoxidized particles, which can be used to change optical signals in sensing devices.

Metal nanoparticles, if unconstrained, can agglomerate or become larger by processes known as Ostwald ripening. These processes can be enhanced by chemical and thermal exposures. The sensing nanoparticles described herein are prevented from undergoing these processes by hosting them in a rigid polymer matrix. In some embodiments, rigidity is measured by the lack of segmental motion of the polymer chains unless the material is heated above its glass transition temperature. The host polymer matrix ideally has a glass transition temperature that is considerably above room temperature. In some embodiments, for example, the host polymer matrix has a glass transition temperature greater than or equal to 250° C. In some embodiments, the host polymers have structures containing three-dimensional (3D) monomers fused into their backbone to create an intrinsic free volume. These voids in the associated rigid polymer particles or films can be used to constrain the size of the sensing nanoparticles and prevent ripening and/or agglomeration. In some embodiments, the host polymers are poly(arylene ethers). In some embodiments, the porosity generating 3D structures within the host polymer backbone comprise triptycene, pentiptycene, [2.2.2] bicyclic groups, [2.2.1] bicyclic groups, spirobifluorene groups, and/or other spiro groups. The host polymers can, in some embodiments, have sites that are used to nucleate sensing nanoparticles. These sites can include metal binding sites such as phorphorous, nitrogen, sulfur, or oxygen atoms. In one example, pyridine groups can be used to bind metal ions that nucleate the formation of a sensing nanoparticle. The binding sites can be part of one or more functional groups that actively bind to the sensing nanoparticles and can also be used to stabilize different forms of the sensing nanoparticles and change their response to hydrogen relative to other gas molecules and humidity. The host polymers can also have ionic groups such as sulfates or ammonium ions that can be used for ion exchange reactions with the metal ions that create the sensing nanoparticles. The intrinsic porosity in the host material also facilitates gas diffusion to the sensing nanoparticles. The different environments within the host polymers can give rise to different relative stabilities of the sensing nanoparticles in the absence of hydrogen. For example, it may be of interest to have the metals centers in their predominately neutral (M⁰) valence oxidation state. In other embodiments, the sensing nanoparticles will have predominately metal oxide forms wherein the metal can be in a +1, +2, +3, or +4 oxidation valance state.

The sensing nanoparticles can be assembled along with the host polymers by reducing metal salts in solution to create polymer nanoparticle dispersions. Alternatively, particles can be grown in films of the host particles by impregnating the polymer film with a metal salt and reducing the metal salt to form the nanoparticles. The reduction of the metal salts can be performed chemically, and a non-limiting list of reducing reagents includes amines, hydrazine, hydrogen, alkenes, alkynes, and/or alcohols. In some embodiments, the metals will be reduced electrochemically. In other embodiments, the reduction of the metals can be achieved photochemically. Photochemical reduction of metal salts to create sensing nanoparticles can allow for the sensing nanoparticles to be patterned in different periodic arrays that are capable of creating optical interference effects. In one embodiment, for example, by using two laser beams, an interference effect can be produced that creates a periodic intensity array of light in a thin film, also known as interference lithography. The sensing nanoparticles may form at high intensity lines, and in this way a grating can be formed. In other cases, it may be possible to create square or hexagonal arrangements of materials. There are a variety of different nanofabrication methods that can be used to selectively deposit the sensing nanoparticles, including electron beam treatments, conventional lithography, evaporation through shadow masks, and/or soft-lithography.

The sensing nanoparticle polymer compositions can be utilized to make hydrogen sensors that function based on an electrical mechanism and/or an optical mechanism. In some cases, it may be advantageous to have a combined optical and electrical signal.

Electrical methods may be used by leveraging the change in the oxidizing or reducing nature of the sensing nanoparticles. In one embodiment, for example, a sensing nanoparticle that is in an oxygen-containing atmosphere is most stable in an oxidized valence state, and the sensing nanoparticle may accept electrons from a semiconducting carbon nanotube, which causes the nanotube to have a higher carrier density and higher electrical conductivity. Treatment of this composition with hydrogen gas can reduce the metal oxides, which will reduce the oxidizing nature of the sensing nanoparticle. In this case, some of the electrons extracted from the carbon nanotube are released, allowing them to flow back into the carbon nanotube and reduce the carrier density and lower the electrical conductivity. Similar processes can be possible with other carbon nanomaterials, graphenes, conducting polymers, or other oxidatively activated semiconductive materials. In some embodiments, the sensing nanoparticles return to an oxidized state in ambient atmosphere once the hydrogen gas is not present, and the sensing nanoparticles will in return accept electrons from the semiconductive material to return it to a more conductive state.

In other electrical sensing embodiments, the sensing nanoparticles can be made to be stable in what is largely a neutral state. In this state, hydrogen can be absorbed into the sensing nanoparticles to create metal hydrides. The absorption of hydrogen may cause the sensing nanoparticles to be more reducing, and if put in contact with a semiconducting material that is capable of accepting electrons to increase its carrier density, the hydrogen exposure can cause an increase in conductivity. Non-limiting semiconducting materials to be paired with the sensing nanoparticles include n-type conducting polymers, SnO₂, WO₃, MoO₃, and/or In₂O₃. This mechanism may be suited for sensing nanoparticle compositions that are largely stable in a neutral state under ambient atmosphere and will return to that state once the hydrogen gas is not present. It is possible that some surface oxide will form on the sensing nanoparticles.

In yet other embodiments, the sensing nanoparticles can mediate electronic conduction between different conductive elements. For example, if the nanoparticles are surrounded by a solution containing an electroactive species, they can modulate its population and contribute to the conductivity.

In optical sensing applications, the plasmonic resonances of sensing nanoparticles that have metals largely in their neutral form wherein the valence electrons are delocalized can be used to modify light, which can be detected in transmission or reflectivity modes. Periodic arrays of plasmonic particles can give rise to narrower features and cooperative effects. The changes in the refractive index can also be used to create optical sensors. In some embodiments, oxidized sensing nanoparticles have a lower refractive index than those that have largely neutral metal ions with delocalized electrons. In this way, hydrogen gas may cause an increase in the refractive index of the sensing nanoparticles. If this material is in contact with a waveguide, microphotonic device, or fiberoptic, the sensing nanoparticle can change the wavelength of a resonance, create interference, or outcouple light traveling within the devices. For example, the resonance optical frequency of a microphotonic ring resonator may change if a polymer coating over the ring resonator containing sensing nanoparticles changes its refractive index. It is also possible that a waveguide structure can be constructed wherein laser light is split into two waveguides and then recombined. Depending on the length of each waveguide, the refractive index of the waveguide, and the refractive index of coatings over the waveguide, different interference between the light beam may be separated and recombined. These effects may be the result of destructive and constructive interference effects. Light reflecting off a surface may also change its angle of reflection with changes of the refractive index of an overcoating. This mechanism can also be used to create sensing measurements. Optical grating structures produced by arrays of sensing nanoparticles can also have different reflection wavelengths and efficiencies depending upon the changes in the refractive index of the sensing nanoparticle coating.

### Example 2

Current hydrogen gas (H₂) detection methods include optical, mechanical, electrochemical, and chemiresistive methods. The ideal sensor should have miniaturized form factors and a low power requirement to allow easy distributed on-site deployment and persistent monitoring. Chemiresistive H₂ sensors are attractive and have been extensively studied, as only simple electrical readouts are required to enable the continuous and real-time monitoring of H₂ concentrations. The state-of-the-art H₂ sensors include palladium (Pd)-based materials, wherein the selective absorption and reaction with H₂ creates a change in the work function and resistivity of the metal. To achieve high sensitivity, nanoscopic highly reactive Pd structures are needed. A challenge, however, is that high surface area materials are thermodynamically unstable with regard to Ostwald ripening, which creates larger structures. It has been previously demonstrated that thin films of porous triptycene-containing poly(arylene ether)s (PAEs) restrict the growth of silver, gold, and bimetallic palladium-platinum nanoparticles (NPs). The PAEs have small pores that limit the growth of the metal nanoparticles during the in situ reduction process. In this study, this strategy was extended to synthesize controlled small Pd NPs in colloidal dispersion, which allows processability and scalability. These polymer-Pd NPs were used to functionalize Single-Walled Carbon Nanotube (SWCNT) chemiresistors and graphene field-effect transistors (GFETs) to achieve the sensitive, selective, and robust detection of H₂ under ambient conditions.

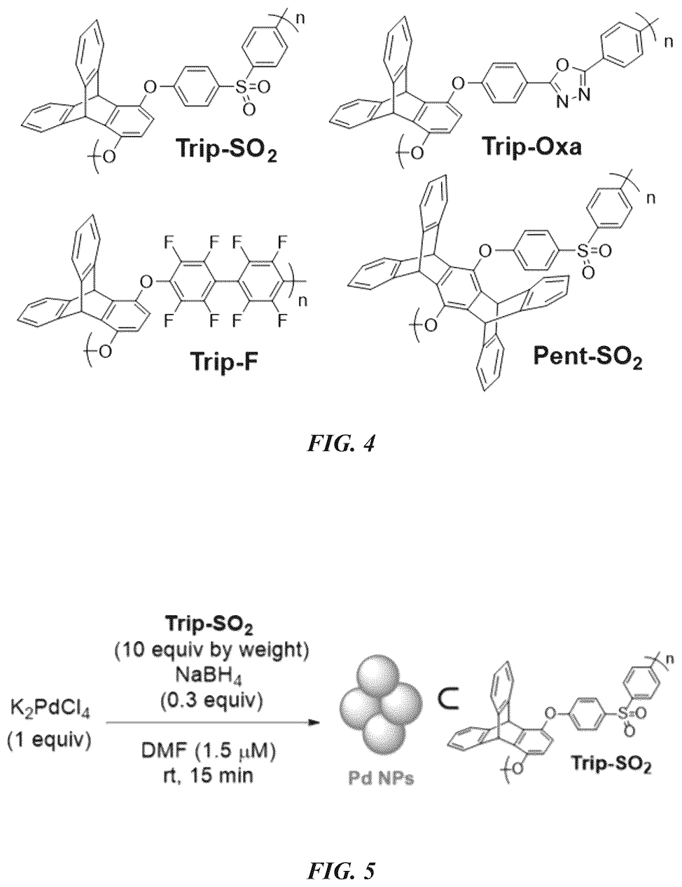

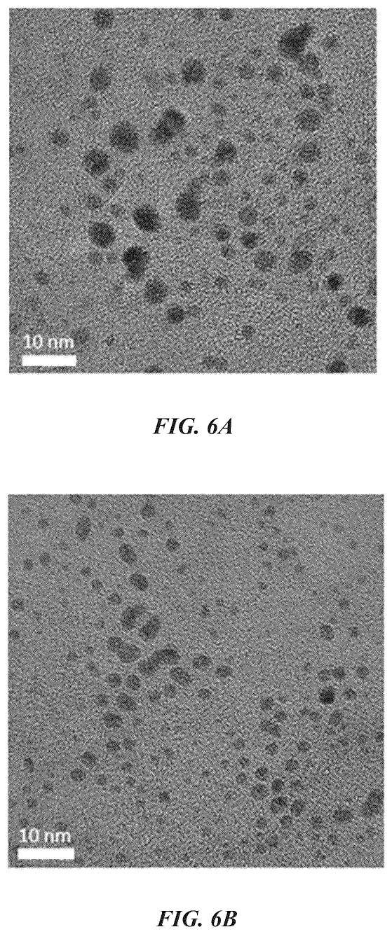

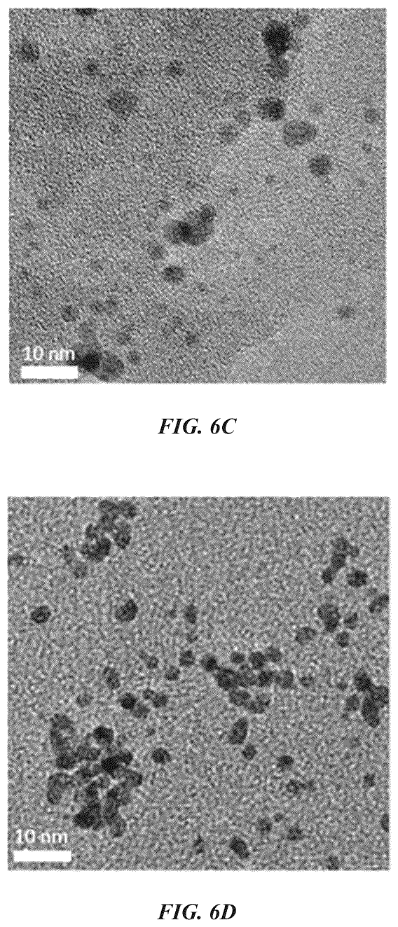

Iptycene-containing PAEs were synthesized via a microwave-assisted S_{N}Ar polycondensation reaction between triptycene-1,4-diol/pentiptycene-6,13-diol and the respective fluoro-containing partners, yielding PAEs Trip-SO₂, Trip-Oxa, Trip-F, and Pent-SO₂ (FIG. 4). The resulting polymers were characterized by gel permeation chromatography (GPC) and nuclear magnetic resonance (NMR) (FIGS. 32-35). The iptycene-containing PAEs were dissolved in DMF with K₂PdCl₄, and Pd NPs were generated by subsequent NaBH₄ reduction (FIG. 5). Upon the addition of NaBH₄ solution, the reaction mixtures instantaneously turned reddish brown, indicating the formation of Pd NP dispersions. To examine the effect of PAEs on the Pd nanoparticle growth, the resulting Pd NP dispersions were characterized by transmission electron microscopy (TEM). As shown in FIGS. 18A-18B, Pd NPs synthesized in the presence of Trip-SO₂ (Trip-SO₂-Pd) have significantly smaller diameters (3-5 nm) than the control Pd NPs in the absence of PAE (>200 nm). It should be noted that Trip-SO₂-Pd was observed to be homogenous and well-dispersed across large areas (FIG. 18). The Trip-SO₂-Pd dispersion also possessed high stability and stayed in solution after weeks of storage. To confirm the chemical identity of the nanoparticles, energy dispersive X-ray (EDX) elemental mapping was performed on Trip-SO₂-Pd and the Pd peaks correlated to the NP images (FIGS. 19A-19C). Similarly, as shown in FIGS. 6A-6D, other iptycene-containing PAEs also yielded small Pd NPs where the majority of the Pd NP diameter falls under 5 nm. To highlight the importance of the iptycene units in supporting the size-limited Pd NPs, the Pd NPs synthesis was also performed with the common poly(ether ether sulfone) (PEES) that does not contain iptycene moieties (FIG. 20A). In this case, the Pd NPs rapidly aggregated and phase-separated as shown in FIG. 20B. Collectively, iptycene-containing PAEs in the synthesis of stable size-limited Pd NP dispersions have been demonstrated.

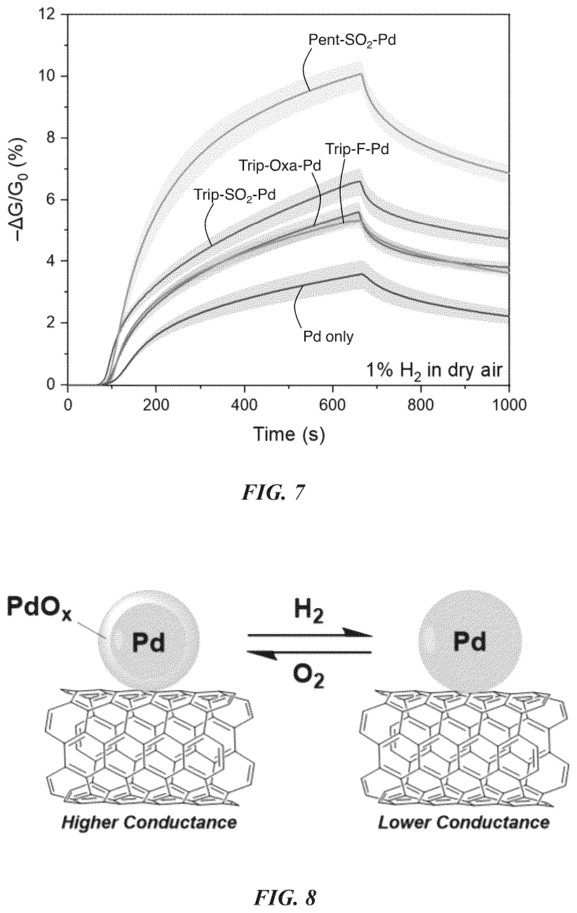

To investigate the potential of these PAE-supported Pd NPs in hydrogen sensing, chemiresistive SWCNT-based devices were fabricated, as illustrated in FIG. 8. In this process, SWCNTs were dispersed and drop-casted over gold electrode arrays to form a conductive network. Subsequently, PAE-supported Pd NPs dispersions were drop-casted on top of the SWCNT network, serving as the selector element that interacts with the analyte and the SWCNTs in the sensing device. The surface morphology of drop-casted PAE:Pd NP films was characterized with scanning electron microscopy (SEM). As shown in FIGS. 22A-22D, the films retain the porous structures that are expected from the parent PAEs, providing fast kinetics for analyte diffusion. For the initial screening, the chemiresistive devices fabricated were exposed to 1% H₂ for 10 minutes in dry air at room temperature and the change in resistance was converted to the negative normalized change in conductance as the sensing readout (−ΔG/G₀, wherein ΔG and G₀ are the change in conductance and baseline conductance, respectively). As shown in FIG. 7, reversible decreases in conductance upon exposure to H₂ gas, and excellent tolerances to oxygen, were observed. Shaded areas represent the standard deviations in the chemiresistive responses measured. When compared to larger Pd NPs synthesized in the absence of PAEs (Pd only), all PAE-supported Pd NPs showed significantly higher responses, which is expected from the smaller Pd NPs. In particular, Trip-SO₂-Pd and Trip-Oxa-Pd were observed to respond more strongly to H₂ than Trip-F-Pd, possibly due to the more coordinating nature of the sulfone and oxazole groups in the polymers that help to facilitate the sensing signal transduction. Pent-SO₂-Pd displayed the highest sensitivity toward H₂ with an averaged 10.1% change in conductance, higher than the averaged 6.6% response from its triptycene counterpart, suggesting the beneficial effect of the pentiptycene moiety in this composite sensory material.

The mechanism for chemiresistive H₂ sensing by Pd-based materials has been postulated to involve the absorption of H₂ and the formation of palladium hydrides in the α- and/or β-phase that result in an increase in resistivity and a change in work function. However, as the Pd NPs are scattered across the SWCNT network in this system, a change in the surface doping effect of the Pd NPs with H₂ seems more likely. Specifically, a reduction-oxidation mechanism (FIG. 8) is possible where the palladium nanoparticles oxidized in air are reduced by H₂ to Pd(0), similar to conventional PdO-based H₂ sensors. The reduced nanoparticles release electrons that compensate the holes in the p-doped SWCNTs to produce the observed decrease in conductance. When H₂ is removed from the atmosphere, Pd(0) species are re-oxidized by the ambient air and give rise to the recovery of the SWCNT conductance.

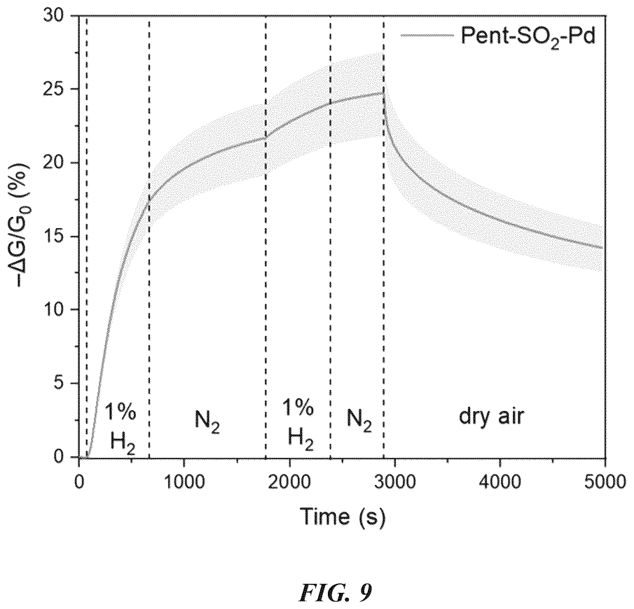

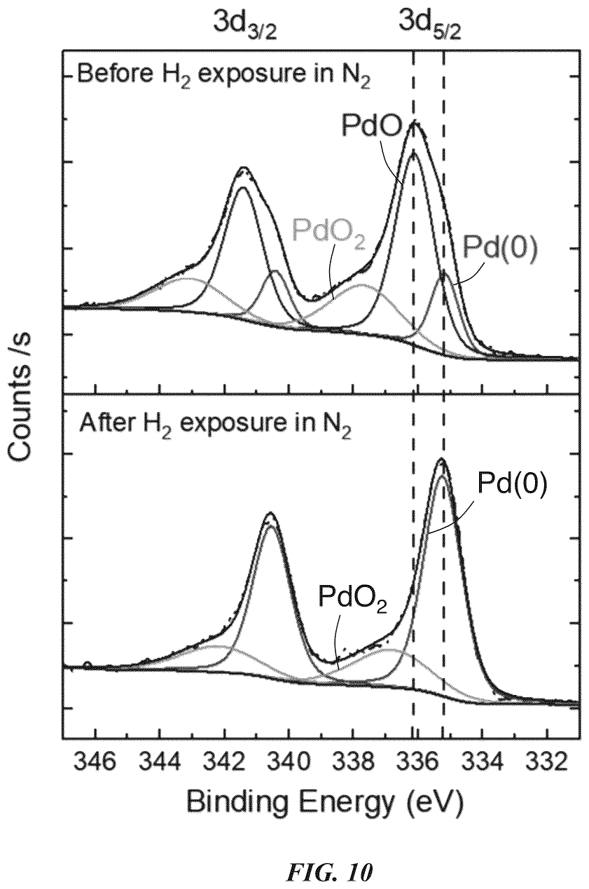

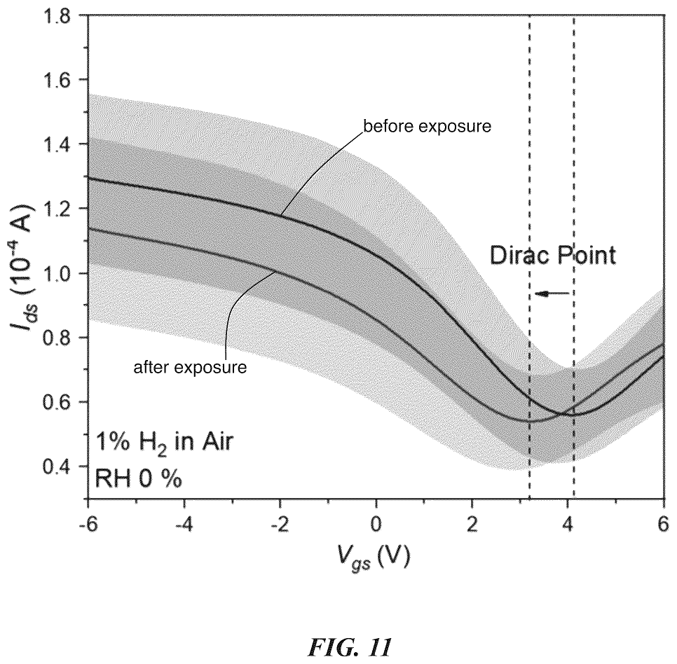

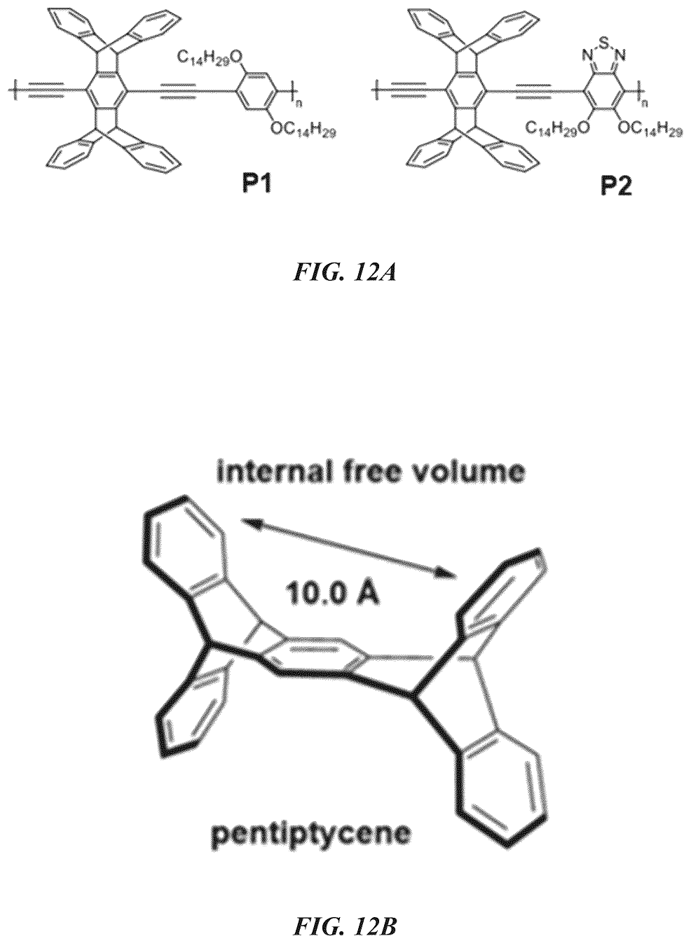

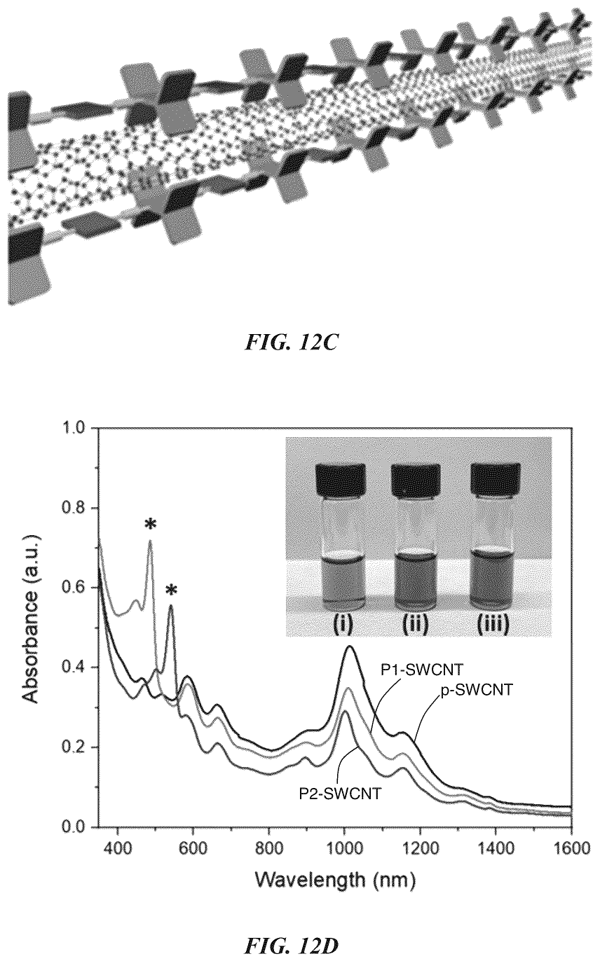

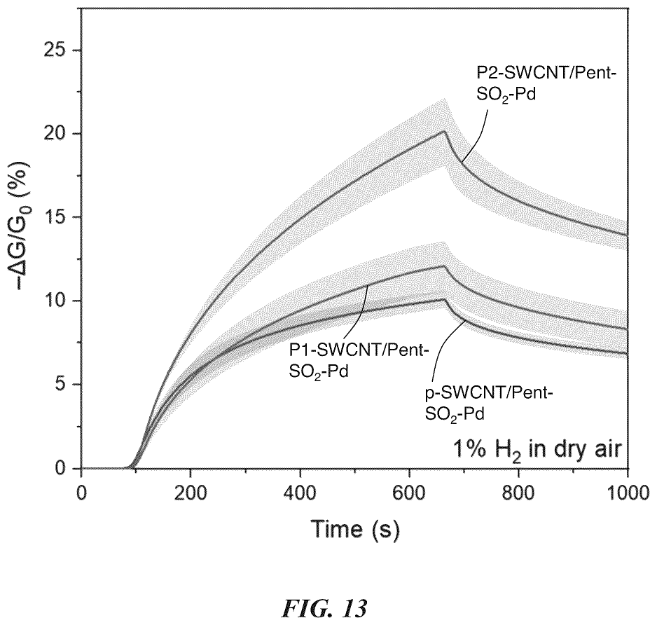

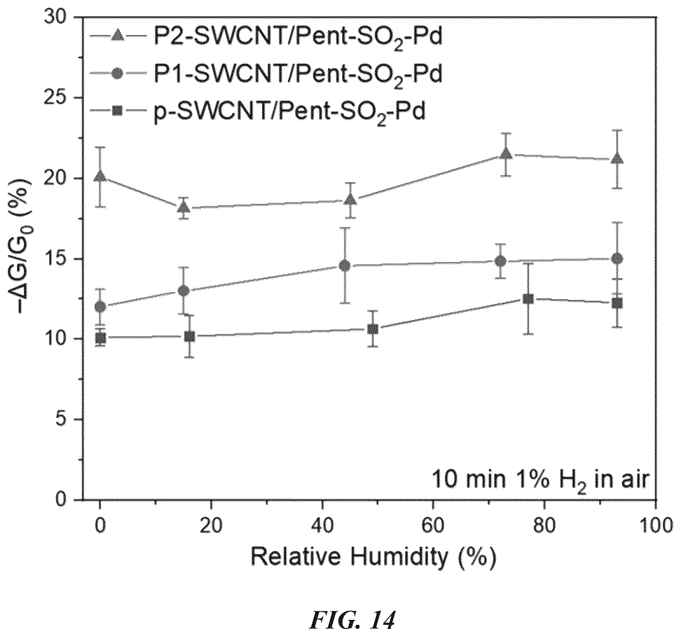

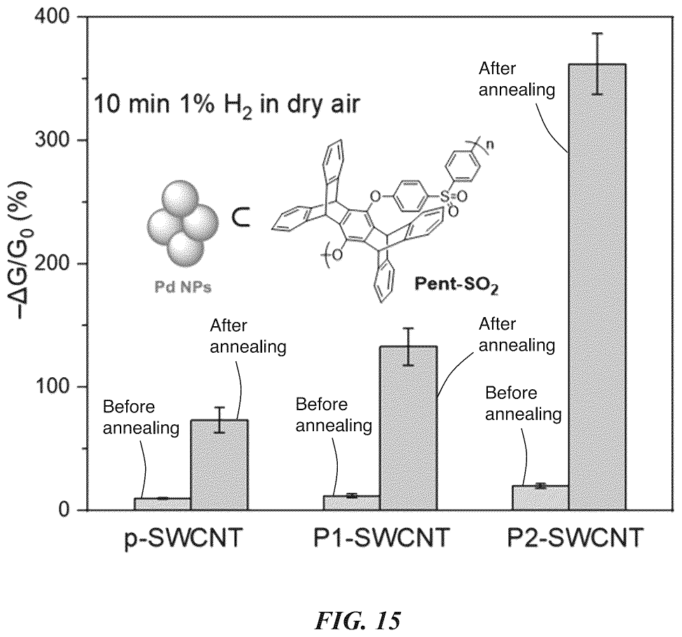

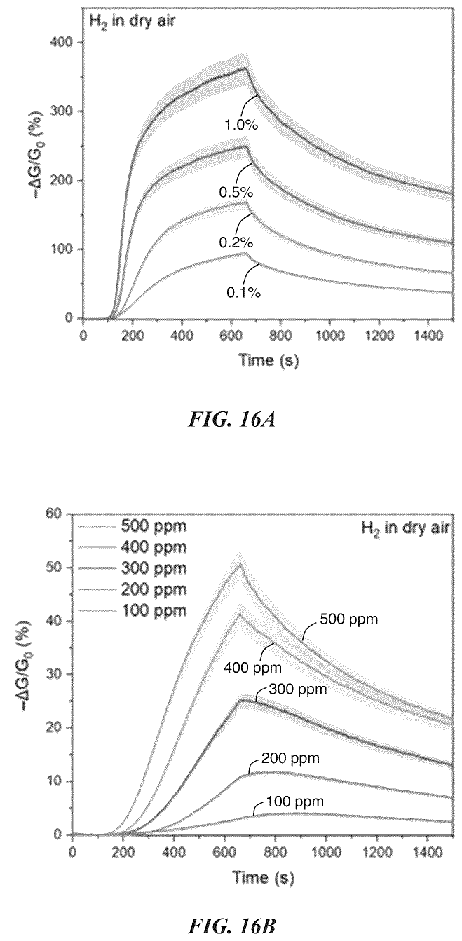

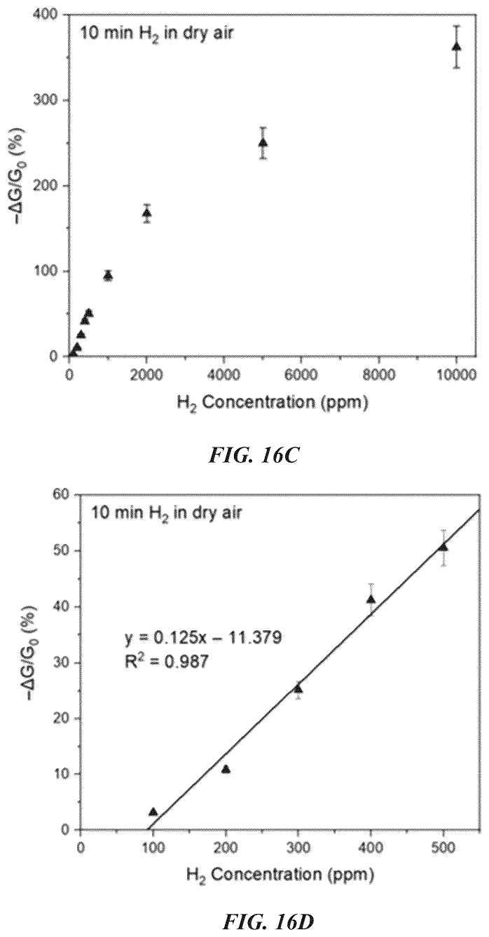

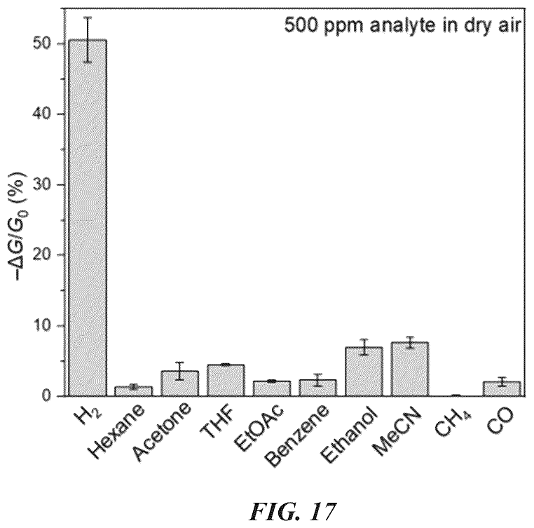

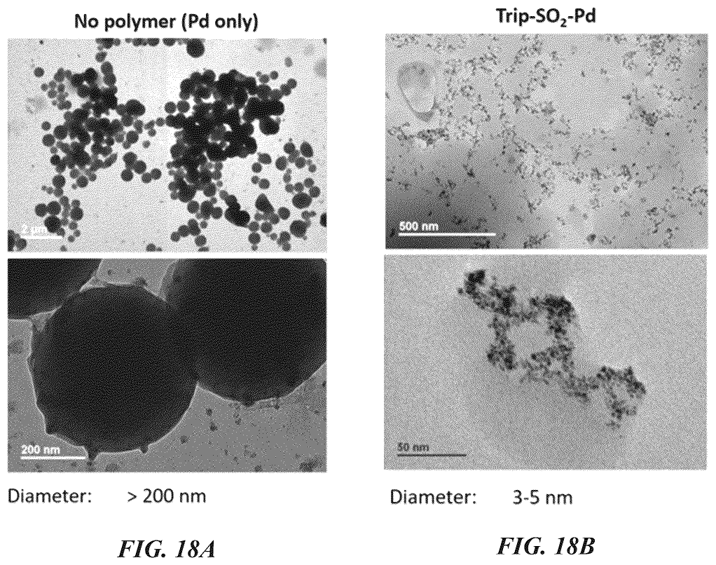

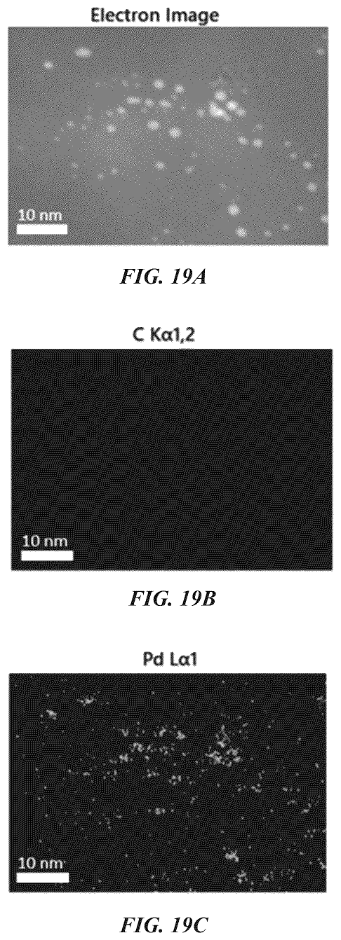

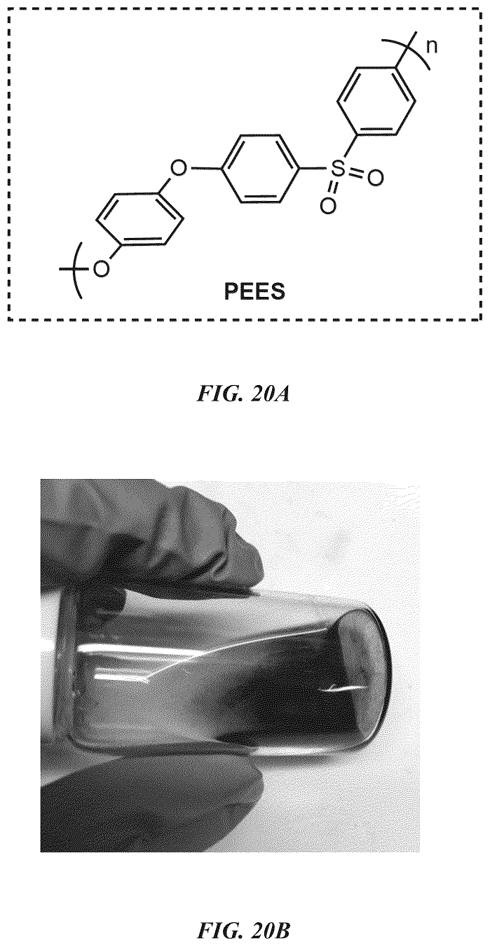

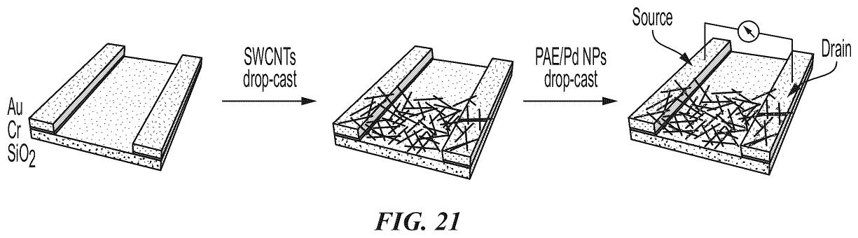

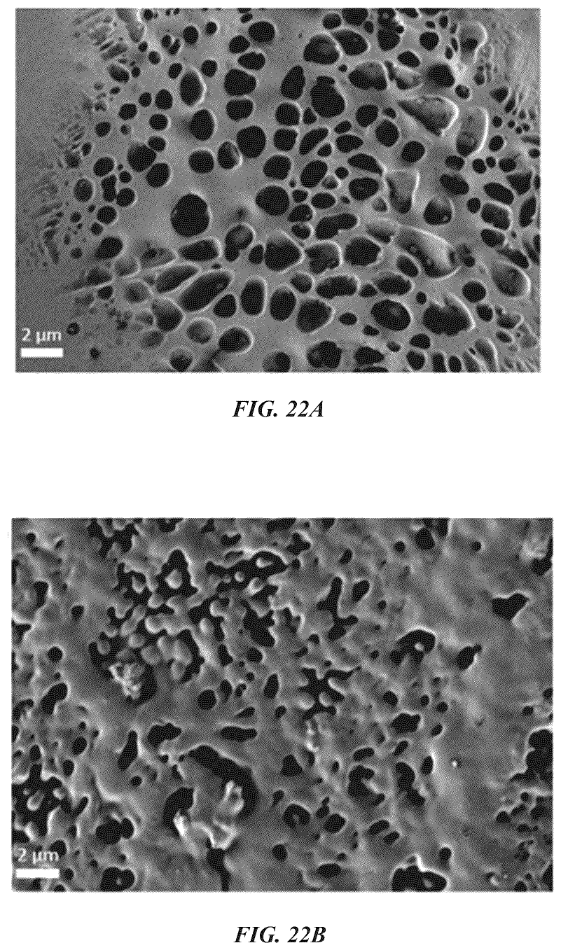

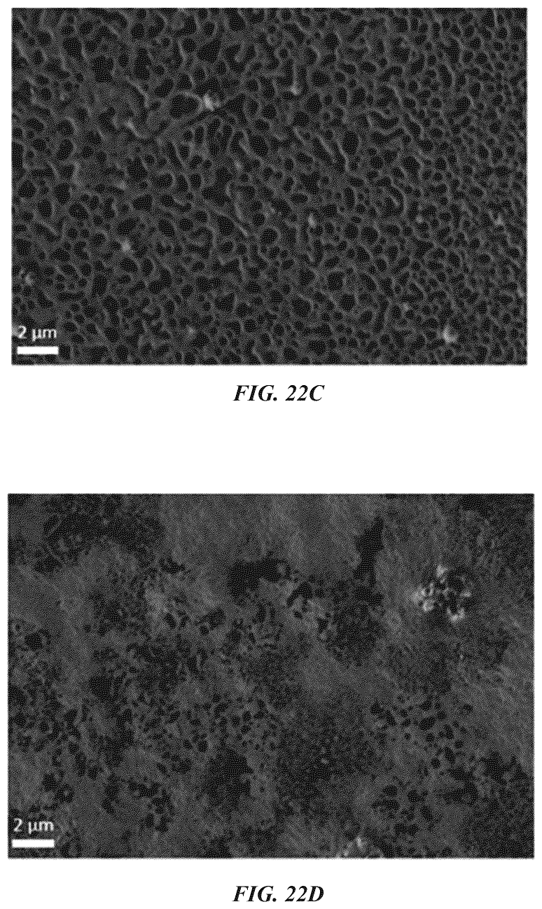

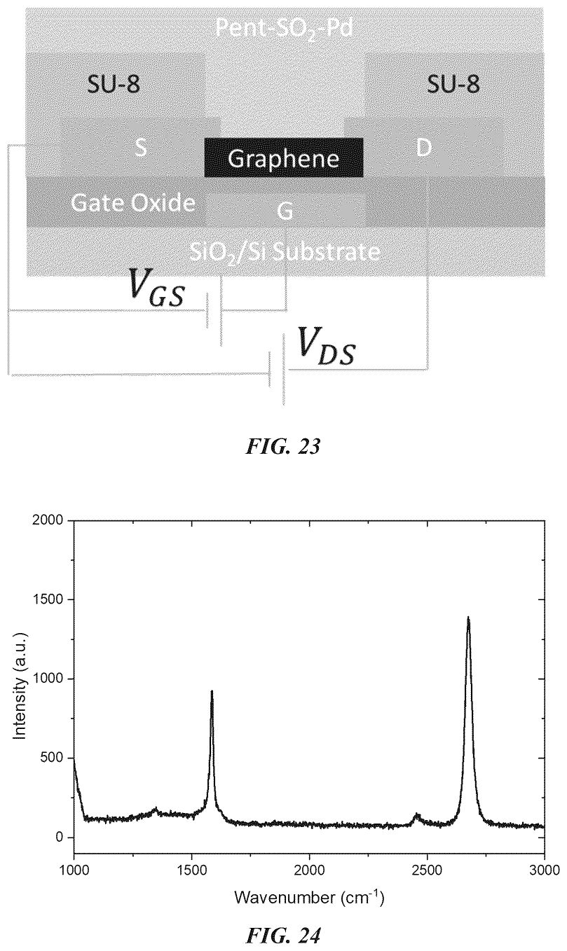

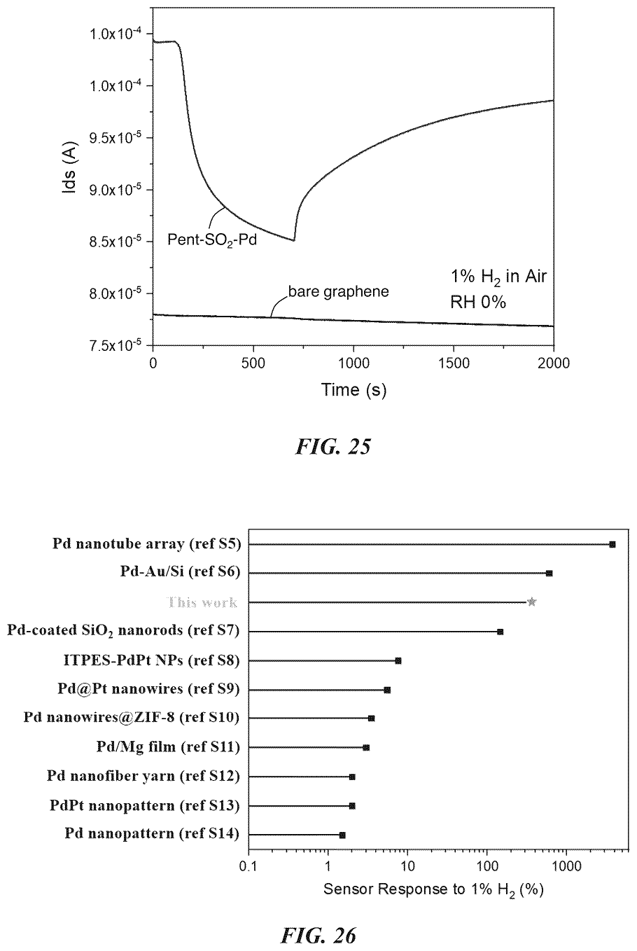

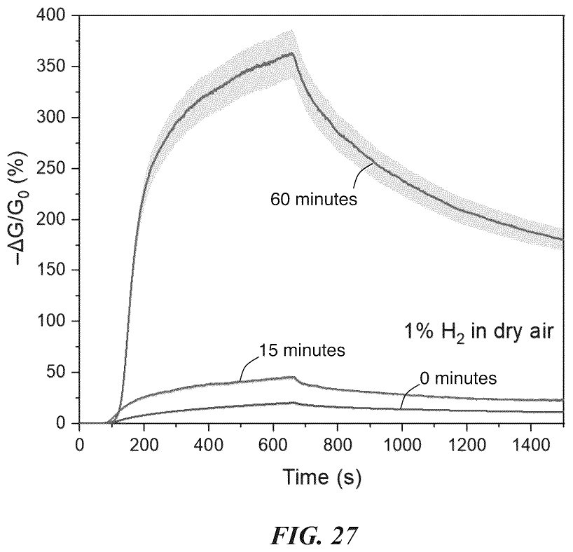

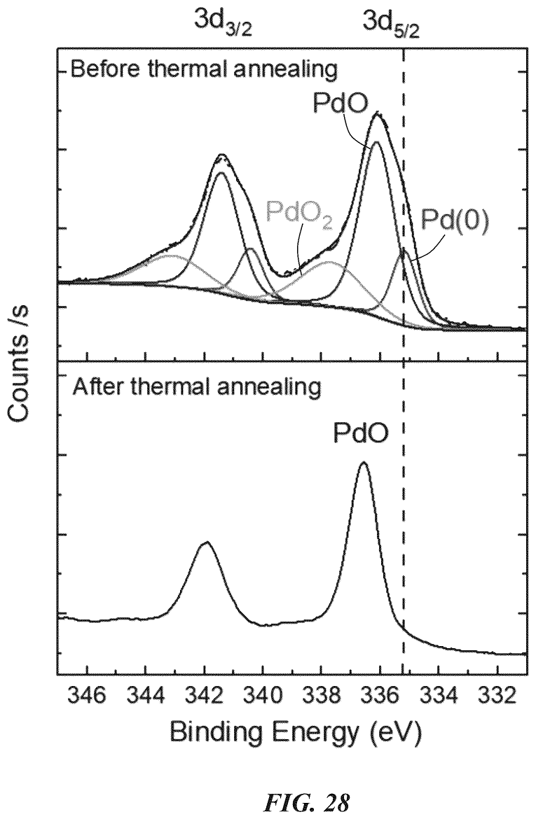

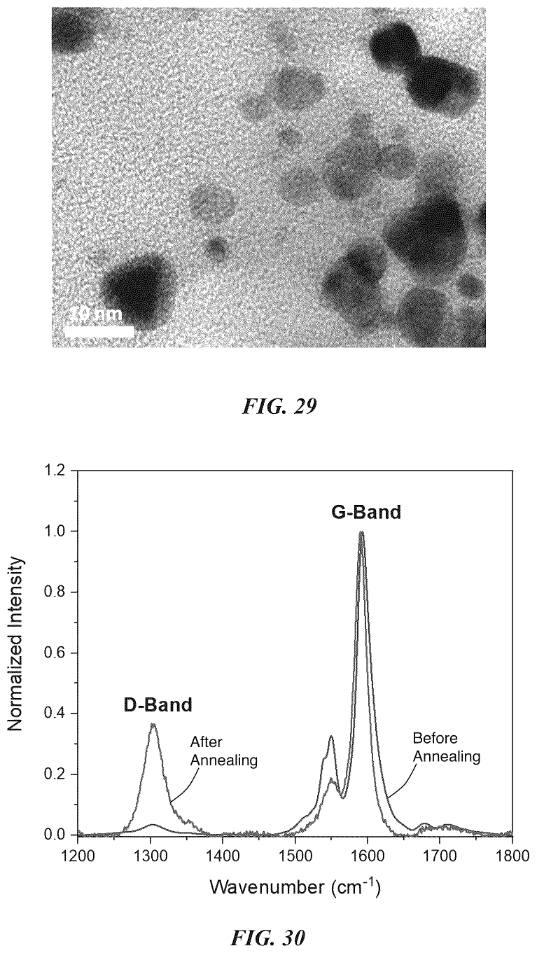

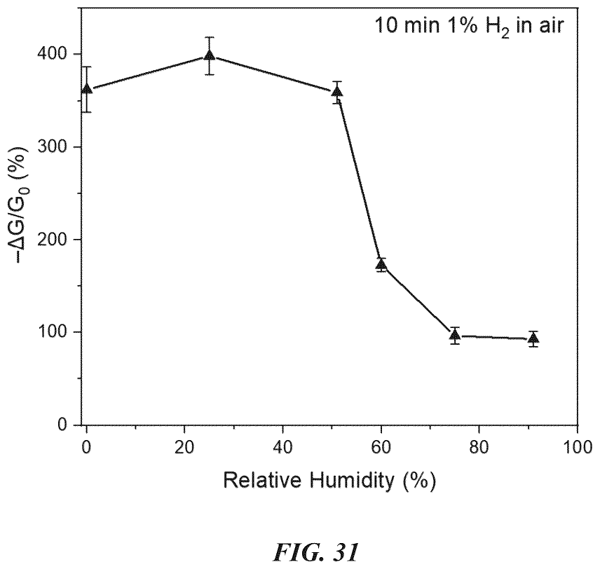

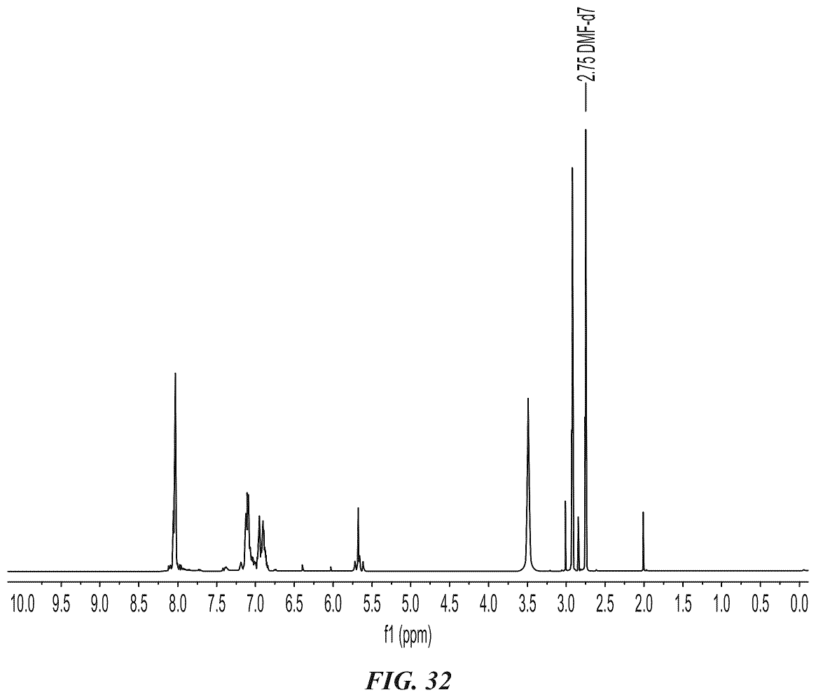

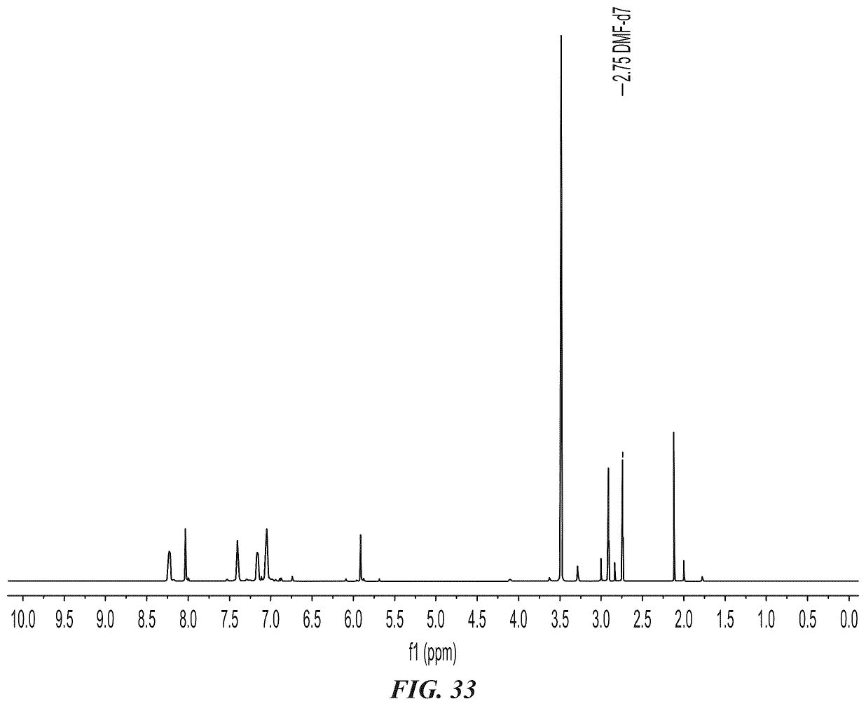

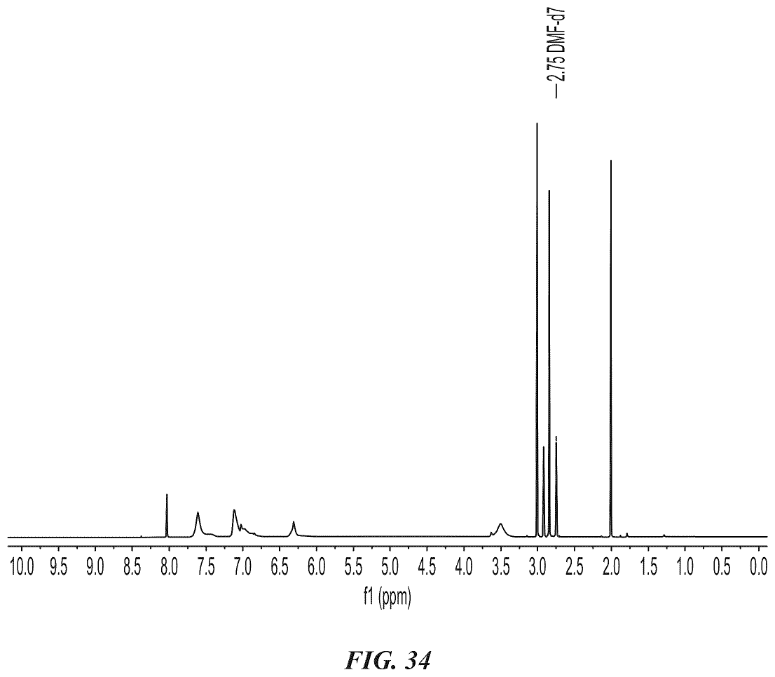

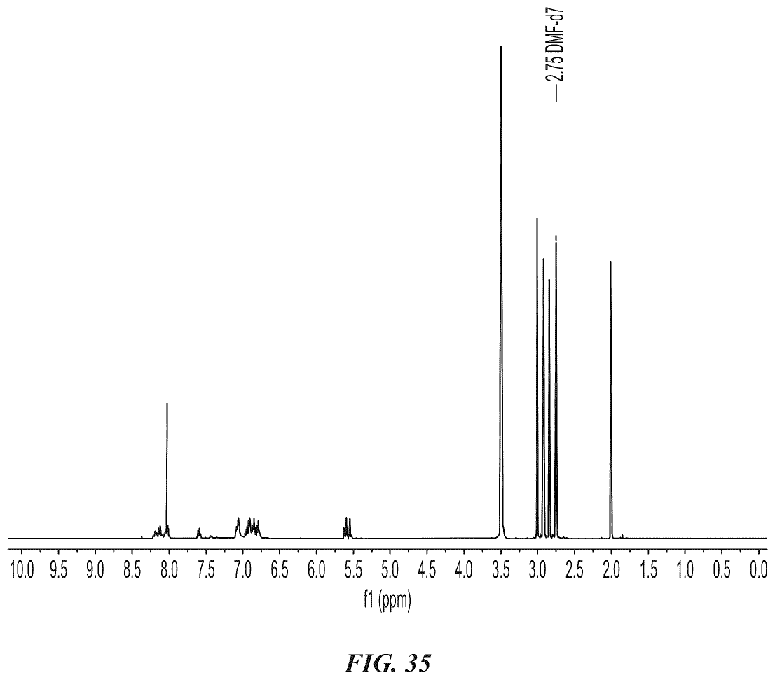

To test this hypothesis, Pent-SO₂-Pd was exposed to 1% H₂ under a nitrogen atmosphere. As shown in FIG. 9, Pent-SO₂-Pd responded more strongly to 1% H₂ in nitrogen than in dry air (17.4% vs 10.1%), consistent with the right shift in the proposed equilibrium that favors the formation of the reduced palladium species in nitrogen. Subsequently, when H₂ gas was switched off and the sensor was allowed to rest in nitrogen, no recovery of conductance was observed. This lack of reversibility indicates that the hydrogen sensor does not operate under the absorption-desorption mechanism found in conventional Pd-based chemiresistive H₂ sensors. Moreover, this irreversible reduction process in nitrogen also resulted in a significantly smaller chemiresistive response during the second H₂ exposure. At the last stage where the carrier gas was switched back to dry air, a rapid conductance increase was observed as the sensors start to recover. The sensor recovery under oxygen corroborates the proposed reduction-oxidation sensing mechanism.

In search of further evidence for the reduction process, the PAE-supported Pd NPs were characterized with X-ray Photoelectron Spectroscopy (XPS) to evaluate the oxidation states of Pd species during H₂ sensing. High-resolution XPS Pd 3d spectra of Pent-SO₂-Pd were investigated before and after the H₂ exposure (FIG. 7). Multiple Pd peaks were observed in the fabricated Pent-SO₂-Pd device that can be assigned to Pd(0), PdO, and PdO₂. Upon H₂ exposure, Pd 3d peaks of palladium oxides significantly diminished whereas Pd(0) became the predominant Pd species found in the material, suggesting the effective reduction by H₂. This observation by XPS further supports the reduction-oxidation sensing mechanism.

The PAE-supported Pd NPs were also applied to graphene sensors based on field-effect transistors (GFETs). Single-layer graphene is highly sensitive to the surface electronic perturbation, and has been used widely as the transduction material in sensing. An array of GFET devices were fabricated (FIG. 23) with low defect single-layer graphene (FIGS. 24) and then Pent-SO₂-Pd was drop-casted on the surface. As shown in FIG. 25, a significant and reversible chemiresistive response from the GFET was observed upon exposure to 1% H₂ in dry air, whereas the control GFET with bare graphene gave a negligible response. The electronic properties of GFETs can be readily modulated by gate potential, which can provide insight into the sensing mechanism. FIG. 11 reveals the transfer characteristics of the GFETs with Pent-SO₂-Pd before and after the H₂ exposure. The current between source and drain (I_{ds}) was measured when the applied gate voltage (V_{gs}) was swept from −6 to 6 V. A notable left shift (˜1 V) of the Dirac point (minimum conduction point) in the I-V curve was observed after the H₂ exposure, indicating an n-type doping effect as a result of the interaction between the Pd NPs and H₂. This observation is consistent with the proposed reduction-oxidation sensing mechanism. Moreover, it has been demonstrated that the use of PAE-supported Pd NPs can be extended to other sensing platforms and may be incorporated into highly multiplexed sensing arrays.

The sensitivity of SWCNT-based chemiresistors depends on the SWCNT purity and the semiconducting content, and it is desirable to purify/sort the commercial SWCNTs to improve their chemiresistive response. A diameter-selective SWCNT dispersion method using poly(p-phenylene ethynylene)s (PPEs) containing pentiptycene moieties has been previously demonstrated. Polymers P1 and P2, as illustrated in FIG. 12A, were shown to selectively disperse SWCNTs with diameters of 0.8-0.9 nm with the exclusion of amorphous carbon impurities and metallic SWCNTs with larger diameters. Polymers P1 and P2 were used to disperse SWCNTs, and the dispersed SWCNTs were subsequently isolated by centrifugation, filtration, redispersion, and washing to remove the excess polymer. The resulting purified SWCNTs were dispersed in oDCB (P1-SWCNT and P2-SWCNT) and showed interesting green and pink colors with high dispersion stability (FIG. 12D, inset). The absorption spectra (FIG. 12D) of P1-SWCNT and P2-SWCNT displayed new absorption peaks (*) that do not belong to either the pristine SWCNTs (p-SWCNT) or the pentiptycene polymers. These peaks are likely new charge transfer between the polymer and SWCNTs. Sensing devices using the pre-sorted P1-SWCNT and P2-SWCNT with Pent-SO₂-Pd showed significant improvement in the H₂ sensitivity (FIG. 13). Specifically, when compared to the 10.1% conductance change achieved by p-SWCNT/Pent-SO₂-Pd, chemiresistive devices made from P1-SWCNT/Pent-SO₂-Pd and P2-SWCNT/Pent-SO₂-Pd showed 12.0% and 20.1% change in conductance, respectively. This trend of sensitivity is consistent with previous studies in benzene, toluene, and o-xylene (BTX) sensing where similar pentiptycene polymer/SWCNT dispersions were used as sensing elements. These improvements demonstrate that polymer sorting of SWCNTs is an effective strategy to modulate the chemiresistive sensitivity of the SWCNT-based devices.

Notably, these sensors containing PAE-supported Pd NPs showed excellent tolerance to humidity, which often compromises the performance in chemiresistive H2 sensors. The Pent-SO₂-Pd-based sensors examined were able to perform well at high humidity (>90% relative humidity) and maintained a similar level of sensitivity across the relative humidity range investigated (FIG. 14). This observation is in stark contrast to many conventional Pd-based systems and can be attributed to the PAE-supported Pd NPs preventing mechanisms wherein water interrupts the desired H₂-Pd NP reactions or the Pd NP-SWCNT interactions.

It was found that thermally annealing the fabricated sensing devices produces a drastic sensitivity increase to H₂. Various SWCNTs sensing devices containing Pent-SO₂-Pd were placed in a muffle oven at 275° C. for 1 hour under air. As shown in FIG. 15, large improvements were observed for all the devices in response to 1% H₂. Notably, thermally annealed P2-SWCNT/Pent-SO₂-Pd displayed a remarkable 18-fold increase in sensitivity (362% change in conductance), making it comparable to the most sensitive Pd-based chemiresistive sensors in response to 1% H₂ under ambient conditions (FIG. 26). A shorter annealing time (15 minutes) was attempted (FIG. 27) and a 2-fold increase in H₂ sensitivity was observed. Consistent with the reduction and oxidation of the Pd species, thermally annealing the Pd NPs at an elevated temperature could produce a larger amount of Pd oxides, which would result in a larger change with the subsequent H₂ reduction. To verify this hypothesis, high-resolution XPS of Pd 3d region was performed on the thermally annealed Pd NPs, showing most of the Pd(0) converted to PdO species (FIGS. 28-29). Also, a significant decrease in the baseline conductance was observed, which can be attributed to the oxidation of SWCNTs during the thermal annealing process. To evaluate if changes in the SWCNTs occurred, the thermally annealed samples were characterized by Raman Spectroscopy. A significant increase in the D-band/G-band ratio, which is an indicator for surface defect density, was observed after the thermal annealing process (FIG. 30). The oxygen defect sites introduced on SWCNTs surface may lead to the direct binding of the Pd NPs, which facilitates the changes in charge transfer that is the basis of the transduction mechanism. The improvement in H₂ sensitivity after thermal annealing may be the result of both Pd NPs oxidation and SWCNTs modification.

The range of concentrations over which a sensor accurately operates is of general interest. As shown in FIGS. 16A-16B, thermally annealed P2-SWCNT/Pent-SO₂-Pd was tested under a wide range of H₂ concentrations from 100 ppm to 1% (10,000 ppm). In the high H₂ concentration regime, thermally annealed P2-SWCNT/Pent-SO₂-Pd displayed plateau responses during the end of the H₂ exposure, showing signs of sensor saturation. On the other hand, when H₂ was at low ppm levels, no significant saturation was observed in the sensing traces. Notably, a 3.2% conductance change was observed in response to 100 ppm H₂. The sensor saturation at high concentrations is revealed by the non-linearity in FIG. 16C. However, the responses to H₂ at ppm levels display a linear correlation (FIG. 16D) to allow accurate quantification of H₂ concentration. The limit of detection (LOD) is calculated to be 91 ppm from the linear fit. It should be noted that this LOD is far below the sensitivity requirement of 1000 ppm outlined by the United States Department of Energy (DOE). As illustrated in FIG. 16B, the sensors did not show signs of saturation after the 10 minute exposure at low H₂ concentrations, suggesting their potential to achieve a much lower LOD with a longer exposure time.

We examined the selectivity of the sensors through exposure to potential interfering analytes. Thermally annealed P2-SWCNT/Pent-SO₂-Pd was exposed to a wide variety of common volatile organic compounds (VOCs) and gases such as methane and carbon monoxide. As shown in FIG. 17, at the concentration of 500 ppm, thermally annealed P2-SWCNT/Pent-SO₂-Pd displayed one order of magnitude higher responses towards H₂ than other interferents, highlighting its excellent selectivity. We have also evaluated the humidity effect on the H₂ sensing for thermally annealed P2-SWCNT/Pent-SO₂-Pd. As shown in FIG. 31, the response towards 1% H₂ is largely maintained until high humidity (>60% relative humidity). The higher sensitivity to humidity reflects the more hydrophilic character of the PdO-rich NPs and functionalized SWCNTs after the thermal annealing process. Nevertheless, this level of humidity tolerance still allows for practical sensor deployment in most scenarios.

Reported herein is the synthesis of colloidal size-limited Pd NPs with iptycene-containing PAEs, which can be used to create sensitive, selective, and robust chemiresistive hydrogen sensors. Rather than the conventional absorption-desorption sensing mechanism, a reduction-oxidation mechanism was found to be operative in this SWCNT-based construct and reversible H₂ sensing responses were achieved in ambient air. Moreover, these size-limited PAE-supported Pd NPs can be used to create GFET sensors that were also used to elucidate the sensing mechanism. The excellent humidity tolerance may be attributed to the PAE groups. Pre-sorting of SWCNTs by complexation to pentiptycene polymers and thermal annealing enhance the sensor performance, which can be generalized to guide future sensor design.

Materials: Commercial reagents were purchased from Sigma-Aldrich, Alfa Aesar, Combi-Blocks, Oakwood, and Ambeed and used as received unless otherwise noted. Deuterated solvents were purchased from Cambridge Isotope Laboratories and used as received. Single-walled carbon nanotubes [Signis SG65i, lot no.: MKBZ1159V; (6,5) chirality, ≥93% carbon as SWCNT; 0.7-0.9 nm diameter] were purchased from Sigma-Aldrich and used as received. Hydrogen, methane, and carbon monoxide gas cylinders were purchased from Airgas. TEM grid (Carbon Type-B, 300 mesh, Copper) was purchased from Ted Pella. Triptycene-1,4-diol, pentiptycene-6,13-diol, P1, and P2 were synthesized according to procedures in literature.

Instrumentation: NMR spectra were recorded using a Bruker Avance 500 MHz NMR spectrometer. Polymer samples were analyzed in tetrahydrofuran (THF) using an Agilent 1260 Infinity GPC system with variable wavelength diode array (254, 450, and 530 nm) and refractive index detectors. The instrument was calibrated with narrow-dispersity polystyrene standards between 1.7 and 3150 kg mol⁻¹. Polymer samples were also analyzed in 25 mM LiBr DMF using an Agilent 1260 Infinity setup with two Shodex KD-806M columns in tandem. The differential refractive index (dRI) was monitored using a Wyatt Optilab T-rEX detector. The light scattering was monitored using a Wyatt DWAN HELEOS-II detector. Tip sonication was performed with Qsonica Q125 Sonicator. Microwave-assisted reactions were performed with a CEM Discover 2.0 Microwave Synthesizer. Raman spectra were collected using a Horiba Jobin-Yvon LabRam (Model HR 800) Raman confocal microscope with a 633 nm laser. X-ray photoelectron spectroscopy (XPS) measurements were performed on a Thermo Scientific K-Alpha+X-ray photoelectron spectrometer. TEM characterization and EDX mapping were performed via a 120kV FEI Tecnai Multipurpose Digital TEM (G2 Spirit TWIN). SEM characterization was conducted with a Merlin and Crossbeam 540 Zeiss. Absorption spectra were obtained using an Agilent Cary 4000 UV-vis-NIR spectrophotometer. Mass flow controllers (MFCs) were purchased from Alicat Scientific, with carrier gas flow rates (air or nitrogen) controlled using an MC-10SLPM-D/5M and hydrogen flow rates controlled using an MC-10SCCM-D/5M. Flow rates were controlled with Flow Vision SC software (Alicat Scientific; available free of charge online) using a script. Analyte gases were generated by a FlexStream FlexBase module with precise temperature (±0.01° C.) and gas flow rate control (±1.5% of the reading). Resistance was measured using an Agilent Keysight 34970A equipped with a 34901A 20-channel multiplexer (2/4-wire) module. The Agilent Keysight 34970A was connected to a laptop using an Agilent 82357B GPIB-USB interface high-speed USB 2.0 serial cable and controlled using BenchLink Data Logger 3. The scan rate was set to 1 scan/second.

Synthesis of Trip-SO₂: A 5 mL microwave vial was charged with a magnetic stir bar, triptycene-1,4-diol (0.20 mmol) and bis(4-fluorophenyl) sulfone (1 equiv.). 2 mL anhydrous N,N-dimethylacetamide (DMAc) was added and the reaction mixture for sparged with nitrogen for 15 minutes, followed by addition of K₂CO₃ (2 equiv.). The reaction mixture was heated to 200° C. for 1 hour under microwave irradiation. After the reaction mixture was cooled to room temperature, it was precipitated in methanol. The white precipitates were filtered and washed with water and dried in vacuo. GPC (THF): Mn=1.6×10⁴ Da, PDI=1.4.

Synthesis of Trip-Oxa: A 5 mL microwave vial was charged with a magnetic stir bar, triptycene-1,4-diol (0.20 mmol) and 2,5-bis-(4-fluorophenyl)-1,3,4-oxadiazole (1 equiv.). 2 mL anhydrous DMAc was added and the reaction mixture for sparged with nitrogen for 15 minutes, followed by addition of K₂CO₃ (2 equiv.). The reaction mixture was heated to 200° C. for 1 hour under microwave irradiation. After the reaction mixture was cooled to room temperature, it was precipitated in methanol. The white precipitates were filtered and washed with water and dried in vacuo. GPC (THF): Mn=2.0×10⁴ Da, PDI=1.6.

Synthesis of Trip-F: A 5 mL microwave vial was charged with a magnetic stir bar, triptycene-1,4-diol (0.20 mmol) and decafluorobiphenyl (1 equiv.). 2 mL anhydrous DMAc was added and the reaction mixture for sparged with nitrogen for 15 minutes, followed by addition of K₂CO₃ (2 equiv.). The reaction mixture was heated to 200° C. for 1 hour under microwave irradiation. After the reaction mixture was cooled to room temperature, it was precipitated in methanol. The white precipitates were filtered and washed with water and dried in vacuo. GPC (THF): Mn=1.0×10⁴ Da, PDI=1.9.

Synthesis of Pent-SO₂: A 5 mL microwave vial was charged with a magnetic stir bar, pentiptycene-6,13-diol (0.20 mmol) and bis(4-fluorophenyl) sulfone (1.05 equiv.). 2 mL anhydrous DMAc was added and the reaction mixture for sparged with nitrogen for 15 minutes, followed by addition of K₂CO₃ (2 equiv.). The reaction mixture was heated to 160° C. for 1 hour under microwave irradiation. After the reaction mixture was cooled to room temperature, it was precipitated in methanol. The white precipitates were filtered and washed with water and dried in vacuo. GPC (DMF, soluble fraction): Mn=4.2×10⁴ Da, PDI=1.8.

General procedure for the synthesis of palladium nanoparticles with poly(arylene-ether)s (PAEs): A 20 mL scintillation vial was charged with a magnetic stir bar. PAE (10 mg) K₂PdCl₄ (1.0 mg), and 2 mL of anhydrous N,N-dimethylformamide (DMF) were added and sonicated to dissolve the materials. Subsequently, 5 microlitres of a solution of NaBH₄ in anhydrous DMF (70 mg NaBH₄ in 1 mL DMF) was added and the solution was stirred at room temperature for 15 minutes.

Preparation of SWCNT dispersion: For pristine SG65i SWCNTs, a stock solution of SG65i SWCNTs (2 mg) was prepared in o-dichlorobenzene (oDCB) (20 mL) by bath sonication at room temperature (RT) for 30 minutes. Subsequently, the suspension was allowed to stand overnight undisturbed. For polymer/SWCNT dispersions, polymer (2 mg) was dissolved in ortho-dichlorobenzene (oDCB, 2 mL), and the solution was sonicated in a water bath for 10 minutes. To the polymer solution was added 0.2 mg of SG65i SWCNTs, and the resulting mixture was chilled with ice and homogenized for 20 minutes using a Qsonica Q125 sonicator at 63W with a pulse sequence (10 seconds ON and 5 seconds OFF). Subsequently, the suspension was centrifuged for 3 hours at 22000 g. The supernatant was removed, filtered, dispersed in oDCB, filtered, and washed with copious amount of chloroform, THF, and acetone. The resulting SWCNT film was re-dispersed in oDCB (10 mL) to yield the final polymer/SWCNT dispersion.

Chemiresistive device preparation: Glass slides (VWR microscope slides) were bath sonicated in acetone for 15 minutes and then dried with a stream of nitrogen. Using an aluminum mask, chromium (15 nm) followed by gold (50 nm) was deposited using a Thermal Evaporator (Angstrom Engineering), leaving a 0.5 mm gap between gold electrodes. A 1 μL amount of the SWCNT dispersion was drop-casted in between the gold electrodes and dried at RT under house vacuum in a desiccator or vacuum oven. Subsequently, a 1 μL amount of the PAE-supported Pd NPs dispersion was drop-casted in between the gold electrodes and dried at RT. Finally, the fabricated sensor device was soaked in Milli-Q water for 1 hour to remove residual NaBH₄ and dried at RT under house vacuum in a desiccator or vacuum oven.

Graphene field effect transistor (GFETs) preparation: Fabrication of the GFETs started with a piranha cleaned 4-inch silicon wafer. 5 nm Ti and 100 nm Au were deposited as gate electrodes using electron beam deposition. 20 nm of aluminum oxide film was deposited using atomic layer deposition (ALD). Another two layers of metal stacks (Ti/Au) were deposited to form the source and drain contacts of the sensor array. 20 nm of aluminum oxides as the interlayer dielectric was deposited using ALD. BCl₃ plasma was used to etch openings on the oxide film. The wafer was then diced into chips. Graphene coated with poly(methyl methacrylate) (PMMA) (ACS Materials Trivial Transfer Graphene™ 1 cm×1 cm) was transferred on the chip to cover the sensing area. The chip was baked at 60° C. for 30 minutes and 130° C. for 15 minutes. The chip was immersed in acetone overnight to remove the PMMA film. Graphene film was isolated into individual channels with oxygen plasma and a patterned PMGI/AZ3312 resist stack as a mask. The chip was then immersed in N-methyl-2-pyrrolidone (NMP) for serval hours to strip away the resist. The sensing chip was passivated with 500 nm of patterned SU8 film, where only the graphene channel was exposed to functionalization and analytes. The sensing chip was cleaned with isopropyl alcohol (IPA) and blow dried with s nitrogen gun. Finally, a 1 μL amount of the PAE-supported Pd NPs dispersion was drop-casted on the GFETs and dried at RT under house vacuum in a desiccator or vacuum oven.

Graphene field effect transistors (GFETs) measurement: All electrical measurements were performed using a custom-built measurement system at room temperature. For I-V sweep measurements, the drain-source voltage Vd s was held constant and the gate-source voltage V_{gs} was swept from −6 V to 6 V in 50 mV increments. A 10-second hold time was used before the gate-source voltage V_{gs} was swept at a rate of 50 mV/500 ms. For chemiresistive measurement, V_{gs} was zero and V_{gs} was held constant at 500 mV. The current of the graphene channel was sampled every 500 ms.

Thermal annealing of sensor device: The fabricated sensor devices were placed in a muffle oven at 275° C. for 1 hour under ambient air, followed by cooling to room temperature. Theoretical Limit of Detection (LOD) Calculation: The limit of detection was calculated following literature procedures. The root-mean-square (rms) noise deviation in conductance of the baseline prior to analyte exposure was first calculated. 60 consecutive data points were taken prior to exposure to hydrogen. The data was plotted and fitted to a fifth-order polynomial using Microsoft Excel. Vₓ_{²} was then calculated using Eq. 1. In this equation, yᵢ is the measured conductance value and y is the corresponding value from the fifth-order polynomial fit. Eq. 2 was then used to calculate rmsₙₒᵢₛₑ of the sensors, where N is the number of data points used for curve fitting (N=60). In Eq. S3, the slope of the linear regression fit for the sensor response vs concentration plot was used to yield the theoretical LOD of the sensors.

$${V}_{{x}^{2}} = \sum {( {y}_{i} - y )}^{2} \qquad ( Eq . 1 )$$

$${rms}_{noise} = \sqrt{\frac{{V}_{{x}^{2}}}{N}} \qquad ( Eq . 2 )$$

$$LOD = \frac{3 ( {rms}_{noise} )}{slope} \qquad ( Eq . 3 )$$

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present invention. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present invention is/are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present invention is directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present invention.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, unless clearly indicated to the contrary, in any methods claimed herein that include more than one step or act, the order of the steps or acts of the method is not necessarily limited to the order in which the steps or acts of the method are recited.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A composition configured for determining hydrogen gas at low concentration, comprising:
a porous polymer having a glass transition temperature greater than or equal to 200° C.; and
metal nanoparticles contained within the porous polymer, wherein an electronic state of at least a portion of the metal nanoparticles changes upon exposure to hydrogen gas.

2. The composition of claim 1, wherein the porous polymer comprises a plurality of pores having an average characteristic dimension less than or equal to 10 nm.

3-4. (canceled)

5. The composition of claim 1, wherein the porous polymer has a BET surface area greater than or equal to 100 m²/g and less than or equal to 1,000 m²/g.

6. The composition of claim 1, wherein the metal nanoparticles have an average characteristic dimension less than or equal to 10 nm.

7-8. (canceled)

9. The composition of claim 2, wherein the metal nanoparticles are contained within the plurality of pores.

10. The composition of claim 2, wherein at least a portion of the metal nanoparticles are immobilized within the plurality of pores.

11. (canceled)

12. The composition of claim 1, wherein the glass transition temperature of the porous polymer is less than or equal to 450° C.

13. The composition of claim 1, wherein the metal nanoparticles comprise palladium (Pd), gold (Au), silver (Ag), copper (Cu), nickel (Ni), cobalt (Co), iridium (Ir), rhodium (Rh), platinum (Pt), alloys thereof, and/or combinations thereof.

14. (canceled)

15. The composition of claim 1, wherein the metal nanoparticles comprise a neutral metal.

16. (canceled)

17. The composition of claim 1, wherein the metal nanoparticles comprise a metal in an oxidation state of +1, +2, +3, or +4.

18. The composition of claim 1, wherein the porous polymer is a poly(arylene ether).

19. The composition of claim 18, wherein the poly(arylene ether) comprises a triptycene group, a pentiptycene group, a [2.2.2] bicyclic group, a [2.2.1] bicyclic group, a spirobifluorene group, and/or combinations thereof.

20. The composition of claim 1, wherein the porous polymer comprises one or more metal interaction sites.

21. The composition of claim 20, wherein the one or more metal interaction sites comprise a P atom, N atom, a S atom, an O atom, and/or combinations thereof.

22. The composition of claim 19, wherein at least a portion of the metal nanoparticles are bound to the one or more metal interaction sites.

23-24. (canceled)

25. The composition of claim 2, wherein at least 50% of the metal nanoparticles are immobilized within the porous polymer.

26. (canceled)

27. The composition of claim 25, wherein at least 25% of a surface area of each metal nanoparticle is exposed to one or more pores of the plurality of pores.

28-29. (canceled)

30. The composition of claim 1, wherein a porosity of the porous polymer allows diffusion of the hydrogen gas to at least 25% of the metal nanoparticles.

31-32. (canceled)

33. The composition of claim 2, wherein at least a portion of the plurality of pores are in fluid communication with an exterior environment of the porous polymer.

34. An article, comprising:
a substrate; and
the composition of claim 1, disposed on at least a portion of the substrate.

35. The article of claim 34, wherein the substrate comprises an electrically conductive material.

36. (canceled)

37. The article of claim 34, wherein the substrate comprises carbon.

38. (canceled)

39. The article of claim 34, wherein the substrate comprises a conducting polymer.

40. The article of claim 34, wherein the substrate comprises an oxide.

41-43. (canceled)

44. The article of claim 34, wherein the composition is coated on at least the portion of the substrate.

45-64. (canceled)
